(19) United States
(12) Patent Application Publication
(10) Pub. No.: US 2015/0361311 A1
(43) Pub. Date: Dec. 17, 2015

(54) HIGHLY-PLASTICIZED CELLULOSE ACETATE ADHESIVES

(71) Applicant: Celanese Acetate LLC, Irving, TX (US)

(72) Inventors: Michael Combs, Pembroke, VA (US); Lizbeth Milward, Blacksburg, VA (US)

(73) Assignee: Celanese Acetate LLC, Irving, TX (US)

(21) Appl. No.: 14/302,691

(22) Filed: Jun. 12, 2014

(51) Int. Cl. C09J 101/12; B32B 7/12; B32B 23/06; B32B 27/06; B32B 23/20; B32B 21/06; B32B 23/08; C08K 5/11; B32B 29/00

(52) U.S. Cl. CPC C09J 101/12; C08K 5/11; B32B 7/12; B32B 23/06; B32B 29/002; B32B 23/20; B32B 21/06; B32B 23/08; B32B 27/06; B32B 2250/02

(57) ABSTRACT

In some instances, an adhesive may include a plasticizer in an amount of about 15% or greater by weight of the adhesive; and a cellulose acetate having a relationship between an acetyl value and an intrinsic viscosity according to Equation 1 of about 2.80 to about 3.85 (or about 2.80 to about 3.20):

$$\frac{{AV}^{2} + {IV}^{2}}{1000} . \qquad Equation 1$$

### BACKGROUND

The exemplary embodiments described herein relate to adhesive compositions, and methods and articles relating thereto.

Adhesives are useful in several applications from arts and crafts (e.g., hot glue sticks) to consumer products (e.g., cigarette seam line adhesives and repositionable, adhesive paper products like sticky-notes) to packaging (e.g., shipping box and cereal box adhesives).

There are several types of adhesives including pressure sensitive adhesives, pressure sensitive hot melt adhesive, hot melt adhesives, and drying adhesives. As used herein, pressure-sensitive adhesives (“PSA”) refer to adhesive compositions that are tacky at room temperature to the extent that a 4 mil (the unit “mil” refers to a thousandth of an inch) coated paper backing sticks to the adhesive composition with no pressure applied (i.e., with only the weight of the 4 mil coated paper backing). In some instances, PSA may be a viscous paste or putty. As used herein, hot melt pressure-sensitive adhesives (“HMPSA”) refer to adhesive composition that sticks to a 4 mil coated paper backing at room temperature with weight applied by a roller of 4.5 pounds or less. HMPSA may be tacky or non-tacky at room temperature. As used herein, hot melt adhesives (“HMA”) refers to adhesive compositions that stick to a 4 mil coated paper backing when heated and do not stick to the 4 mil coated paper backing at room temperature with weight applied by a roller of 4.5 pounds or less. As used herein, a “drying adhesive” refers to an adhesive composition that is liquid at room temperature and often includes a solvent that evaporates to increase the adhesive bond between the adhesive and a surface. Drying adhesives may, for example, be in the form of high viscosity pastes or low viscosity fluids (e.g., spray adhesives).

Common PSA, HMPSA, and HMA utilize synthetic polymers (e.g., ethylene vinyl acetate copolymers, polysiloxanes, and polyurethanes) in combination with additives like tackifiers, waxes, and fillers in varying concentrations and compositions for desired PSA, HMPSA, or HMA. However formulated, these adhesives generally may have poor environmental degradability and generally interfere with recycling processes. For example, in removing labels from glass bottles and repulping of paper products, a caustic bath is used to degrade the paper product. Adhesives with synthetic polymers like ethylene vinyl acetate copolymers, polysiloxanes, and polyurethanes generally stay intact when exposed to caustic baths. Therefore, in some instances, additional steps, often costly, labor-intensive steps, are included in such recycling processes to account for the use of these adhesives. Further, in some instances, depending on the amount of adhesive used and local recycling capabilities, the article may be non-recyclable. Accordingly, PSA, HMPSA, and HMA having increased environmental degradability and compatibility with recycling processes may be useful.

### BRIEF DESCRIPTION OF THE DRAWINGS

The following figures are included to illustrate certain aspects of the embodiments presented herein, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A-E provide illustrations of nonlimiting examples of article configurations according to at least some embodiments described herein.

FIG. 2 provides intrinsic viscosity as a function of the melt temperature for highly-plasticized cellulose acetate adhesives according to at least some embodiments described herein.

### DETAILED DESCRIPTION

The exemplary embodiments described herein relate to PSA, HMPSA, and HMA that comprise highly-plasticized cellulose acetates (“HPCA”), and methods and articles relating thereto. HPCA described herein may, in some embodiments, include a cellulose acetate and a plasticizer, where the plasticizer is at about 15% or greater by weight of the HPCA (e.g., about 15% to about 80% by weight of the HPCA). As used herein, the terms “adhesive(s) of the present disclosure,” “adhesive(s) described herein,” or a derivative thereof refer generally to HMA, PSA, and HMPSA collectively. As used herein, the term “plasticizer” refers to a compound that decreases the glass transition temperature (“T_{g}”) of the polymer being plasticized.

HPCA-adhesives described herein may, in some embodiments, have several advantageous properties like optical clarity, pressure-sensitive adhesive properties, high adhesion strength, and any combination thereof. For example, the adhesive strength of at least some embodiments of the HPCA-adhesives being comparable to that of EVA-based adhesives was unexpected. The HPCA-adhesives described herein have a plurality of avenues through which the properties of the adhesive compositions (e.g., tackiness, clarity, glass transition temperature, adhesive shear strength, degradability, and the like) can be tailored.

The cellulose acetate and high concentration of plasticizer in HPCA described herein may be more environmentally degradable (e.g., via both bulk erosion and chemical degradation) than typical synthetic adhesive polymers like ethylene vinyl acetate copolymers, polysiloxanes, and polyurethanes. Further, cellulose is a product of cellulose acetate decomposition, which may be considered a natural, environmentally benign composition.

Additionally, caustic baths in recycling processes would decompose the cellulose acetates to cellulose, which is the product of caustic bath paper repulping or label removal. Therefore, adhesives that include HPCA would minimally, if at all, impact caustic bath recycling processes.

As used herein, the term “bio-derived” refers to a compound or portion thereof originating from a biological source or produced via a biological reaction. The bio-derived portion of an adhesive described herein refers to the mass percent that is bio-derived.

As used herein, the term “food-grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”).

As used herein, the term “semi-volatile” refers to compounds having a boiling point of about 260° C. to about 400° C.

As used herein, the term “volatile” refers to compounds having a boiling point of about 50° C. to about 260° C.

As used herein, the term “molecular weight” refers to a polystyrene equivalent number average molecular weight (“Mₙ”).

As used herein, the term “water-free” refers to a composition having no more water than is naturally present at standard temperature and pressure with about 100% relative humidity. As used herein, the term “substantially water-free” refers to a composition having no more than about 1% by weight of water above the concentration of water that is naturally present at standard temperature and pressure with 100% relative humidity.

It should be noted that when “about” is used in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

### I. HPCA-Adhesives and Methods Relating Thereto

In some embodiments, the HPCA-adhesives described herein may comprise cellulose acetates and plasticizers, wherein the plasticizers are present in an amount of about 15% or greater by weight of the HPCA-adhesive. In some embodiments, the plasticizers may be present in HPCA-adhesives described herein in an amount ranging from a lower limit of about 15%, 30%, 40%, 50%, or 60% by weight of the HPCA-adhesive to an upper limit of about 80%, 70%, 60%, or 50% by weight of the HPCA-adhesive, wherein the amount may range from any lower limit to any upper limit and encompass any subset therebetween (e.g., about 20% to about 65%). In some embodiments, cellulose acetate may be present in an HPCA-adhesive described herein in an amount ranging from a lower limit of about 20%, 30%, 40%, or 50% by weight of the HPCA-adhesive to an upper limit of about 85%, 70%, 60%, or 50% by weight of the HPCA-adhesive, wherein the amount may range from any lower limit to any upper limit and encompass any subset therebetween. In some embodiments, an HPCA-adhesive described herein may consist essentially of cellulose acetate and plasticizers. In some embodiments, an HPCA-adhesive described herein may consist of cellulose acetate and plasticizers.

HPCA-adhesives described herein may include cellulose acetate having a relationship between an acetyl value (“AV”) and an intrinsic viscosity (“IV”) relationship (“AV/IV relationship”) according to Equation 1 of about 2.80 to about 3.85, where the IV is reported in dL/g. As used herein, the term “acetyl value” refers to the degree of acetylation reported as the acetic acid content as a percent (e.g., cellulose acetate having a degree of substitution of about 2.4 has an AV of about 55%). For example, a cellulose acetate suitable for use in the HPCA-adhesives described herein may have an AV of about 55% and an IV of about 1.5 dL/g, which provides for an AV/IV relationship of about 3.03.

$$\frac{{AV}^{2} + {IV}^{2}}{1000} \qquad Equation 1$$

In some embodiments, the AV/IV relationship for a cellulose acetate suitable for use in conjunction with HPCA-adhesives described herein may range from a lower limit of about 2.80, 2.90, or 3.00 to an upper limit of about 3.85, 3.50, or 3.20, and wherein the AV/IV relationship may range from any lower limit to any upper limit and encompass any subset therebetween.

Cellulose acetates suitable for use in conjunction with HPCA-adhesives described herein may, in some embodiments, have an AV ranging from a lower limit of about 50%, 52%, 54%, or 56% to an upper limit of about 62%, 60%, or 58%, and wherein the AV may range from any lower limit to any upper limit and encompass any subset therebetween.

In some embodiments, cellulose acetates suitable for use in conjunction with HPCA-adhesives described herein may have an intrinsic viscosity ranging from a lower limit of about 0.5 dL/g, 0.7 dL/g, or 1.0 dL/g to an upper limit of about 2.0 dL/g, 1.7 dL/g, 1.5 dL/g, or 1.3 dL/g, and wherein the intrinsic viscosity may range from any lower limit to any upper limit and encompass any subset therebetween. Intrinsic viscosity may be measured by forming a solution of 0.20 g/dL cellulose acetate in 98/2 wt/wt acetone/water and measuring the flow times of the solution and the solvent at 30° C. in a #25 Cannon-Ubbelohde viscometer. Then, the modified Baker-Philippoff equation may be used to determine IV, which for this solvent system is Equation 2.

$$IV = ( \frac{k}{c} ) ( antilog ( ( log {n}_{rel} ) / k ) - 1 ) \qquad Equation 2$$

where

$${n}_{rel} = ( \frac{{t}_{1}}{{t}_{2}} ) ,$$

t₁=the average flow time of solution (having cellulose acetate) in seconds, t₂=the average flow times of solvent in seconds, k=solvent constant (10 for 98/2 wt/wt acetone/water), and c=concentration (0.200 g/dL).

In some embodiments, cellulose acetates suitable for use in conjunction with HPCA-adhesives described herein may have a molecular weight ranging from a lower limit of about 10,000, 15,000, 25,000, 50,000, or 85,000 to an upper limit of about 300,000, 200,000, 150,000, 125,000, 100,000, or 85,000, and wherein the molecular weight may range from any lower limit to any upper limit and encompass any subset therebetween.

Cellulose acetates suitable for use in conjunction with HPCA-adhesives described herein may be derived from any suitable cellulosic source. Suitable cellulosic sources may, in some embodiments, include, but are not limited to, softwoods, hardwoods, cotton linters, switchgrass, bamboo, bagasse, industrial hemp, willow, poplar, perennial grasses (e.g., grasses of the Miscanthus family), bacterial cellulose, seed hulls (e.g., soy beans), kudzu, and the like, and any combination thereof. Further, it has been surprisingly discovered that the clarity of adhesives described herein does not appear to be substantially impacted by the cellulosic source from which the cellulose acetates are derived. This is unexpected because some existing cellulose acetate products (that do not have adhesive properties) require high quality, expensive cellulosic sources (e.g., hardwoods with low hemicellulose content) to achieve high clarity.

In some embodiments, the cellulose acetate suitable for use in conjunction with HPCA-adhesives described herein may be recycled from other cellulose acetate materials. For example, cellulose acetate tow used in producing, for example, cigarette filters may be used for producing HPCA and the adhesives described herein.

Plasticizers suitable for use in conjunction with the HPCA-adhesives described herein may, in some embodiments, include, but are not limited to,

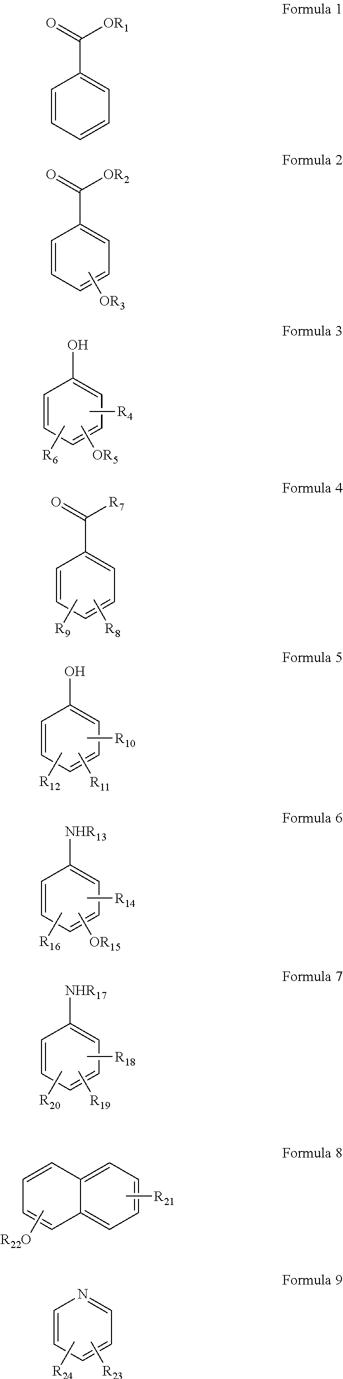

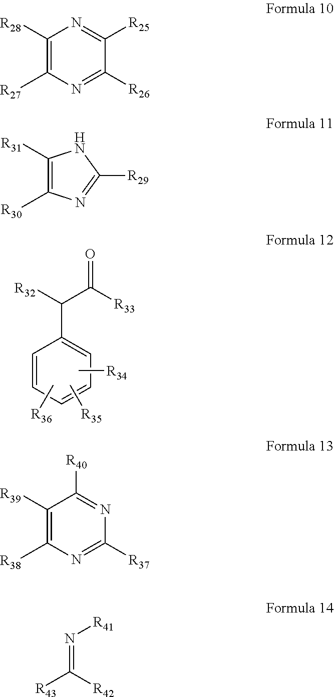

Formula 1 wherein R1 is H, C₁-C₄ alkyl, aryl, or C₁-C₄ alkyl aryl; Formula 2 wherein R2 is H, C₁-C₄ alkyl, aryl, or C₁-C₄ alkyl aryl and R3 is H, C₁-C₄ alkyl, aryl, C₁-C₄ alkyl aryl, acyl, or C₁-C₄ alkyl acyl; Formula 3 wherein R4 and R6 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R5 is H, C₁-C₄ alkyl, aryl, C₁-C₄ alkyl aryl, acyl, or C₁-C₄ alkyl acyl; Formula 4 wherein R7 is H, C₁-C₄ alkyl, aryl, C₁-C₄ alkyl aryl, OH, C₁-C₄ alkoxy, amine, or C₁-C₄ alkyl amine and R8 and R9 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 5 wherein R10, R11, and R12 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 6 wherein R13 is H, C₁-C₄ alkyl, aryl, or C₁-C₄ alkyl aryl, R14 and R16 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide, and R15 is H, C₁-C₄ alkyl, aryl, C₁-C₄ alkyl aryl, acyl, or C₁-C₄ alkyl acyl; Formula 7 wherein R17 is H or C₁-C₄ alkyl and R18, R19, and R20 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 8 wherein R21 is H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R22 is H, C₁-C₄ alkyl, aryl, C₁-C₄ alkyl aryl, acyl, C₁-C₄ alkyl acyl, amine, or C₁-C₄ alkyl amine; Formula 9 wherein R23 and R24 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 10 wherein R25, R26, R27, and R28 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 11 wherein R29, R30, and R31 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 12 wherein R32 is H, C₁-C₄ alkyl, aryl, C₁-C₄ alkyl aryl, R33 is H, C₁-C₄ alkyl, aryl, C₁-C₄ alkyl aryl, OH, C₁-C₄ alkoxy, acyl, C₁-C₄ alkyl acyl, amine, or C₁-C₄ alkyl amine, and R34, R35, and R36 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 13 wherein R37, R38, R39, and R40 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 14 wherein R41 is H, C₁-C₄ alkyl, aryl, C₁-C₄ alkyl aryl, OH, or C₁-C₄ alkoxy and R42 and R43 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazine (1,2,3, 1,2,4, or 1,3,5) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazole (1,2,3 or 1,2,4) with R substituents from each of the cyclic carbons or cyclic nitrogens that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; pyrrole with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperidine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; piperazine with R substituents from each of the cyclic carbons or cyclic nitrogens that are independently H, C₁-C₄ alkyl, aryl, C₁-C₄ alkyl aryl, OH, C₁-C₄ alkoxy, COOH, C₁-C₄ alkyl carboxylate, acyl, C₁-C₄ alkyl acyl, amine, C₁-C₄ alkyl amine, amide, or C₁-C₄ alkyl amide; R44HN—R45-NHR46 where R44 and R46 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R45 is C₁-C₁₀ alkyl; and combinations thereof. As used herein, “alkyl” refers to a substituent with C and H that may be linear or branched (e.g., t-butyl) and saturated or unsaturated. As used herein, “aryl” refers to an aromatic ring that may include phenyl, naphthyl, and aromatic rings with heteroatoms.

Examples of plasticizers suitable for use in conjunction with the HPCA-adhesives described herein may, in some embodiments, include, but are not limited to, triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., γ-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybeonzoate, methyl-4-hydroxybeonzoate, ethyl-4-hydroxybeonzoate, benzyl-4-hydroxybeonzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

Additional examples of plasticizers suitable for use in conjunction with the HPCA-adhesives described herein may, in some embodiments, be nonionic surfactants that include, but are not limited to, polysorbates (e.g., TWEEN®20 or TWEEN®80, available from SigmaAldrich), sorbitan esters (e.g., SPAN® products available from SigmaAldrich), polyethoxylated aromatic hydrocarbons (e.g., TRITON® products available from SigmaAldrich), polyethoxylated fatty acids, polyethoxylated fatty alcohols (e.g., BRIJ® products available from SigmaAldrich), fluorosurfactants, glucosides, and other nonionic surfactants with hydrocarbon tails (e.g., C₆-C₂₂ alkyl groups) and hydrophilic head groups with hydroxyl and ester groups, and combinations thereof. It has been discovered that some nonionic surfactants plasticize cellulose acetates, alone or in combination with small molecule plasticizers. This is unexpected because traditional plasticizers are small molecules. By contrast, nonionic surfactants are bulky with long hydrocarbon tail groups and potentially large head groups. For example, polyoxyethylene (20) sorbitan monolaurate, which is significantly larger than traditional cellulose acetate plasticizers like triacetin, has been observed to plasticize cellulose acetate.

In some embodiments, the plasticizers may be food-grade plasticizers, which may be useful in producing adhesives described herein for use in applications where the adhesive may directly or indirectly contact food (e.g., food containers). Examples of food-grade plasticizers may, in some embodiments, include, but are not limited to, triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and the like, and any combination thereof.

In some embodiments, the plasticizers may be bio-derived, which may be useful in producing adhesive compositions that are bio-derived. For example, bio-derived triacetin, diacetin, tripropionin, glyceryl esters, may be produced from glycerol that is a byproduct of biodiesel. Other examples of plasticizers that may be bio-derived may include, but are not limited to, vanillin, acetovanillone, γ-valerolactone, eugenol, epoxidized soybean oil, castor oil, linseed oil, epoxidized linseed oil, and dicarboxylic esters (e.g., dimethyl adipate, dibutyl maleate). In some instances, aroma plasticizers may be extracts from natural products, and therefore, bio-derived plasticizers.

In some embodiments, the plasticizers may be semi-volatile to volatile plasticizers. Examples of some preferred semi-volatile to volatile plasticizers may include, but are not limited to, glycerol esters, (e.g., triacetin, diacetin, monoacetin), ethylene glycol diacetate, alkyl lactones (e.g., γ-valerolactone), dibutyl maleate, di-octyl maleate, dibutyl tartrate, eugenol, tributyl phosphate, tributyl-o-acetyl citrate, and resorcinol monoacetate.

In some instances, two or more plasticizers may be used in HPCA-adhesives composition. In some instances, it has been surprisingly observed that two or more plasticizers may have synergistic effects. For the same total weight percent of total plasticizer in the HPCA-adhesives, an HPCA-adhesive multiple plasticizers may have a greater melt flow index than an HPCA-adhesive with the individual plasticizers alone, which is an unexpected observation.

In some embodiments, the HPCA-adhesives described herein may further comprise additives. Additives suitable for use in conjunction with the HPCA-adhesives described herein may include, but are not limited to, tackifiers, crosslinkers, insolubilizers, starches, fillers, thickeners, rigid compounds, water-resistance additives, flame retardants, lubricants, softening agents, antibacterial agents, antifungal and/or antimicrobial agents, preservatives, pigments, dyes, antioxidants, UV-stabilizers, resins, rosins, waxes, flowing agents, viscosity modifiers, aromas, and the like, and any combination thereof. In some embodiments, the additives may be present in HPCA-adhesives described herein in an amount ranging from a lower limit of about 0.1%, 1%, 5%, or 10% by weight of the HPCA-adhesive to an upper limit of about 75%, 60%, 45%, or 40% by weight of the HPCA-adhesive, wherein the amount may range from any lower limit to any upper limit and encompass any subset therebetween.

Tackifiers may, in some embodiments, increase the adhesive properties of the HPCA-adhesives described herein. Tackifiers suitable for use in conjunction with the HPCA-adhesives described herein may, in some embodiments, include, but are not limited to, methylcellulose, ethylcellulose, hydroxyethylcellulose, carboxy methylcellulose, carboxy ethylcellulose, amides, diamines, polyesters, polycarbonates, silyl-modified polyamide compounds, polycarbamates, urethanes, natural resins, natural rosins, rosin esters (SYLVATAC® RE85 and SYLVALITE® RE100, both esters of tall oil rosin, available from Arizona Chemical), shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl (meth)acrylates, acrylamides, N-(dialkyl amino alkyl) acrylamide, methacrylamides, hydroxy alkyl (meth)acrylates, methacrylic acids, acrylic acids, hydroxyethyl acrylates, ethylene vinyl acetate, vinyl acetate ethylene polymers, aliphatic hydrocarbons, cycloaliphatic hydrocarbons (e.g., EASTOTAC® products, available from Eastman Chemical Co.), aromatic hydrocarbons, aromatically modified aliphatic hydrocarbons, cycloaliphatic hydrocarbons, hydrogenated versions of the foregoing hydrocarbons, terpenes, polyterpenes, modified terpenes (e.g., phenolic modified terpene resins like SYLVARES™ TP96 and SYLVARES™ TP2040, available from Arizona Chemical), and the like, any derivative thereof, and any combination thereof.

In some embodiments, tackifiers suitable for use in conjunction with the HPCA-adhesives described herein may be food-grade tackifiers. Examples of food-grade tackifiers may, in some embodiments, include, but are not limited to, methylcellulose, ethylcellulose, hydroxyethylcellulose, carboxy methylcellulose, carboxy ethylcellulose, natural resins, natural rosins, and the like, and any combination thereof.

Crosslinkers may, in some embodiments, increase the adhesive properties and/or increase water-resistance of the HPCA-adhesives described herein. Crosslinkers suitable for use in conjunction with the HPCA-adhesives described herein may, in some embodiments, include, but are not limited to, zirconium salts, boric acid, borate salts, ammonium zirconium carbonate, potassium zirconium carbonate, metal chelates (e.g., zirconium chelates, titanium chelates, or aluminum chelates), formaldehyde crosslinkers, polyamide epichlorohydrin resin, crosslinkers containing N-methylol groups and/or etherified N-methylol groups (e.g., ARKOFIX® (an ultra-low formaldehyde crosslinking agent, available from Clariant)), glyoxal, urea glyoxal adduct crosslinkers, urea formaldehyde adduct crosslinkers, melamine formaldehyde, 4,5-dihydroxy-N,N′-dimethylolethyleneurea, hydroxymethylated cyclic ethyleneureas, hydroxymethylated cyclic propyleneureas, hydroxymethylated bicyclic glyoxal diurea, hydroxymethylated bicyclic malonaldehyde diureas, dialdehydes, protected dialdehydes, bisulfite protected aldehydes, isocyanates, blocked isocyanates, dimethyoxytetrahydrafuran, dicarboxylic acids, epoxides, diglycidyl ether, hydroxymethyl-substituted imidazolidinone, 1,3-dimethylol-4,5-dihydroxyimidazolidinone, hydroxymethyl-substituted pyrimidinones, hydroxymethyl-substituted triazinones, epoxides, epoxidized natural oils (e.g., epoxidized soy oil or expoxidized linseed oil), oxidized starch, oxidized polysaccharides, oxidized hemicellulose, and the like, any derivative thereof, and any combination thereof. One skilled in the art with the benefit of this disclosure should understand that formaldehyde crosslinkers should be excluded from use in conjunction with formaldehyde-free HPCA-adhesives, and limited in substantially formaldehyde-free HPCA-adhesives (i.e., the adhesive comprising less than 0.01% formaldehyde by weight of the adhesive). In some embodiments, crosslinkers suitable for use in conjunction with the HPCA-adhesives described herein may be food-grade crosslinkers.

Water-resistance additives may, in some embodiments, increase the water-resistance properties of the HPCA-adhesives described herein, which may consequently yield articles capable of maintaining their mechanical properties in environments with higher water concentrations, e.g., humid environments. Water-resistance additives suitable for use in conjunction with the HPCA-adhesives described herein may, in some embodiments, include, but are not limited to, waxes, polyolefins, insolublizers, ethylene vinyl acetate, vinyl acetate ethylene polymers, octenyl succinyls, alkenyl succinyls, and the like, and any combination thereof.

In some embodiments, water-resistance additives suitable for use in conjunction with the HPCA-adhesives described herein may be food-grade water-resistance additives. Examples of food-grade water-resistance additives may, in some embodiments, include, but are not limited to, waxes, polyolefins, ethylene vinyl acetate, vinyl acetate ethylene polymers, and the like, and any combination thereof.

Fillers may, in some embodiments, increase the rigidity of the HPCA-adhesives described herein, which may consequently increase the mechanical rigidity of an article produced therewith. Fillers suitable for use in conjunction with the HPCA-adhesives described herein may, in some embodiments, include, but are not limited to, coconut shell flour, walnut shell flour, wood flour, wheat flour, soybean flour, gums, starches, protein materials, calcium carbonate, talc, zeolite, clay, rigid compounds (e.g. lignin), thickeners, and the like, and any combination thereof.

In some embodiments, fillers suitable for use in conjunction with the HPCA-adhesives described herein may be food-grade fillers. Examples of food-grade fillers may, in some embodiments, include, but are not limited to, coconut shell flour, walnut shell flour, wood flour, wheat flour, soybean flour, gums, starches, protein materials, calcium carbonate, and the like, and any combination thereof.

Flame retardants suitable for use in conjunction with the HPCA-adhesives described herein may, in some embodiments, include, but are not limited to, silica, metal oxides, phosphates, catechol phosphates, resorcinol phosphates, aromatic polyhalides, borates, inorganic hydrates, and the like, and any combination thereof.

Antifungal and/or antimicrobial agents suitable for use in conjunction with the HPCA-adhesives described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, octynoic acid, and any combination thereof.

Preservatives suitable for use in conjunction with an HPCA-adhesives adhesive described herein may, in some embodiments, include, but are not limited to, benzoates, parabens (e.g., the propyl-4-hydroxybeonzoate series), and the like, and any combination thereof.

Pigments and dyes suitable for use in conjunction with the HPCA-adhesives described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with the HPCA-adhesives described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of the HPCA-adhesives described herein during storage, transportation, and/or implementation. Antioxidants suitable for use in conjunction with the HPCA-adhesives described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with the HPCA-adhesives described herein may be food-grade antioxidants. Examples of food-grade antioxidants may, in some embodiments, include, but are not limited to, ascorbic acid, vitamin A, tocopherols, tocopherol esters, beta-carotene, flavonoids, and the like, and any combination thereof.

Viscosity modifiers may, in some embodiments, be advantageous in modifying the melt flow index of the HPCA-adhesives described herein and/or modify the viscosity of HPCA-adhesives described herein that are in a paste or putty form. Viscosity modifiers suitable for use in conjunction with the HPCA-adhesives described herein may, in some embodiments, include, but are not limited to, polyethylene glycols, polypropylene glycols, and the like, and any combination thereof, which, in some embodiments, may be a food-grade viscosity modifier.

Aromas suitable for use in conjunction with the HPCA-adhesives described herein may, in some embodiments, include, but are not limited to, spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vannillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, benzoin, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascene rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

In some embodiments, HPCA-adhesives described herein may be food-grade HPCA-adhesives that comprise food-grade cellulose acetates and food-grade plasticizers and optionally further comprise food-grade additives.

In some instances, a component of an HPCA-adhesive described herein may perform more than one function in the adhesive described herein. For example, BHT and BHA are both antioxidants and plasticizers for cellulose acetate. In another example, aromas like eugenol, cinnamyl alcohol, camphor, methoxy hydroxy acetophenone (acetovanillone), vanillin, and ethylvanillin may also plasticize cellulose acetate. In yet another example, benzoates and parabens (e.g., the propyl-4-hydroxybeonzoate series) may be both preservatives and plasticizers for cellulose acetate.

In some embodiments, the adhesive compositions described herein may be at least in part bio-derived adhesive compositions. In some embodiments, the amount of the adhesive composition that is bio-derived may range from a lower limit of about 2%, 5%, 10%, 25%, 50%, 75%, or 90% to an upper limit of about 100%, 99%, 95%, 90%, 75%, or 50%, and wherein the amount of the adhesive composition that is bio-derived may range from any lower limit to any upper limit and encompasses any subset therebetween.

In some embodiments, the HPCA-adhesives described herein may comprise cellulose acetates (e.g., having a degree of substitution described herein, a molecular weight described herein, from a cellulosic source described herein, and a combination thereof), plasticizers (e.g., one or more specific plasticizers describe herein, food-grade plasticizers described herein, aroma plasticizers described herein, and a combination thereof), and optionally additives described herein (e.g., one or more specific additives describe herein, at amounts described herein, and a combination thereof), wherein the plasticizers are present in an amount of about 15% or greater by weight of the HPCA-adhesive (including specific ranges described herein or subsets thereof).

In some embodiments, the HPCA-adhesives described herein may comprise cellulose acetates (e.g., having a degree of substitution described herein, a molecular weight described herein, from a cellulosic source described herein, and a combination thereof), plasticizers (e.g., one or more specific plasticizers describe herein, food-grade plasticizers described herein, aroma plasticizers described herein, and a combination thereof), and optionally additives described herein (e.g., one or more specific additives describe herein, at amounts described herein, and a combination thereof), wherein the plasticizers are present in an amount of about 15% or greater by weight of the HPCA-adhesive (including specific ranges described herein or subsets thereof).

In some embodiments, the HPCA-adhesives may be HMA as defined herein. In some instances, HPCA-HMA described herein may include plasticizers in an amount of about 5% to about 60% by weight of the adhesive composition, including subsets therebetween. Non-tacky HPCA-HMA may be in the form of a sheet, pellets, sticks, molded products, and the like. It should be noted that the term “sheet” should not be interpreted to be limited in thickness and encompasses films, layers, and the like. In some embodiments, such HPCA-HMA may be melted and used for melt casting a laminate onto a substrate. In some instances, the adhesive compositions may be disposed on a substrate like a plastic or paper label, heated, and applied to a second substrate like a glass or plastic bottle.

In some embodiments, the HPCA-adhesives may be HMPSA as defined herein. In some instances, HPCA-HMPSA described herein may include plasticizers in an amount of about 30% to about 75% by weight of the adhesive composition, including subsets therebetween. In some instances, such adhesive compositions may be tacky or non-tacky at room temperature. In some instances, heat may be used to enhance the tackiness of an adhesive composition. Such HPCA-HMPSA may be used in repositionable articles like sticky-notes, labels, window or glass films, and repositionable tabs on diapers. In some instances, such an adhesive composition may increase in strength over time, which may allow for initial repositioning of the article (e.g., an advertisement or logo on a wall, window, or vehicle) and then strengthening of the adhesive to be permanent to semi-permanent.

In some embodiments, the HPCA-adhesives may be PSA as defined herein. In some instances, HPCA-PSA described herein may include plasticizer in an amount of about 40% to about 90% by weight of the adhesive composition. Such HPCA-PSA may be in the form of a paste, a putty, and the like.

It should be noted that the concentration of plasticizers in the different types of adhesive compositions overlap because the properties and, consequently, the type of the adhesive composition depend on, inter alia, the composition of the plasticizers and cellulose acetates. In some instances, the concentration of plasticizers relative to the classification of the adhesive composition may fall outside the preferred ranges described herein. It has been observed that with the same cellulose acetates and concentration of plasticizer, but different plasticizer compositions, different types of adhesive compositions can be produced. One skilled in the art with the benefit of this disclosure should recognize that the preferred ranges described herein for the plasticizers relative to the type of adhesive composition are not limiting, and, in some instances, a plasticizer concentration may fall outside these preferred ranges to produce an adhesive composition of a specific type (i.e., PSA, HMPSA, or HMA).

The physical and chemical properties of cellulose acetates and plasticizers described herein may be tailored to achieve the desired characteristics of the HPCA-adhesives. Examples of such properties may include, but are not limited to, the degree of substitution of substituent of the cellulose acetates, the molecular weight of the cellulose acetates, the composition of the plasticizers, and the like, and any combination thereof. Further, the amount of plasticizer in the HPCA-adhesives described herein may be tailored to achieve the desired characteristics of the HPCA-adhesives.

The characteristics of the HPCA-adhesives described herein that can be tailored may include, but are not limited to, flow onset point, glass transition temperature, melt flow index, adhesive strength, degradability, clarity, and the like, and any combination thereof.

Tailoring the flow onset of the HPCA-adhesives described herein may enable use of the HPCA-adhesives over a wide variety of applications. For example, lower flow onset points may be useful in pressure-sensitive HPCA-adhesives, while higher flow onset points may be useful in thermal laminating sheets, each application of which is discussed in more detail herein. In some embodiments, tailoring the flow onset point of the HPCA-adhesives described herein may be achieved by, inter alia, changing the plasticizer concentration (e.g., decreasing the concentration to increase the flow onset point), changing plasticizer composition, changing the degree of substitution or composition of the cellulose acetate, and changing the molecular weight of the cellulose acetate (e.g., decreasing molecular weight to decrease the flow onset point).

In some embodiments, the HPCA-adhesives described herein may have a flow onset point of about 220° C. or less. In some embodiments, the HPCA-adhesives described herein may have a flow onset point ranging from a lower limit of about 50° C., 70° C., 80° C., 100° C., 110° C., 130° C., or 150° C. to an upper limit of about 220° C., 200° C., 170° C., 150° C., 130° C., or 110° C., and wherein the flow onset point may range from any lower limit to any upper limit and encompass any subset therebetween. In some embodiments, the HPCA-adhesives described herein may have no flow onset point.

Tailoring the glass transition temperature of the HPCA-adhesives described herein may alter the physical characteristics of the HPCA-adhesive at ambient conditions, e.g., stiff or flexible, brittle or pliable, smooth or tacky, and the like, and any combination thereof. As used herein, the term “tacky” refers to a composition that is at least sticky to the touch at room temperature. For example, HPCA-adhesives having no detectable glass transition temperature may be more tacky and flexible than those having a glass transition temperature. As used herein, the term “no detectable glass transition temperature” and derivatives thereof refers to material having no detectable heat flow event (as measured by DSC), which may be caused by the plasticized material having no glass transition temperature or the heat flow broadening to an extent that the glass transition temperature is not detectable.

In another example, HPCA-adhesives having higher glass transition temperatures may be more stiff and/or brittle than those having moderate to low glass transition temperatures. In some embodiments, tailoring the glass transition temperature of the HPCA-adhesives described herein may be achieved by, inter alia, changing the plasticizer concentration (e.g., increasing the concentration to decrease the glass transition temperature), changing the composition of the plasticizer, changing the molecular weight, and changing the degree of substitution of the cellulose acetate (e.g., in some instances, increasing the degree of substitution to increase the glass transition temperature).

The glass transition temperature of an adhesive described herein may be measured by differential scanning calorimetry. In some embodiments, the HPCA-adhesives described herein may have a glass transition temperature of about 190° C. or less. In some embodiments, the HPCA-adhesives described herein may have a glass transition temperature ranging from a lower limit of not measurable, about −75° C., −70° C., −61° C., −55° C., 10° C., 75° C., 120° C., 130° C., or 150° C. to an upper limit of about 190° C., 175° C., or 150° C., and wherein the glass transition temperature may range from any lower limit to any upper limit and encompass any subset therebetween. The glass transition temperature of an HPCA-adhesive can be measured by either differential scanning calorimetry or rheology. One skilled in the art with the benefit of this disclosure would understand that the glass transition temperature value may fall outside the preferred range described herein for different plasticizers used to produce HPCA-adhesive samples. Accordingly, within the scope of the embodiments described herein, the glass transition can be manipulated based on the composition and concentration of additives included in the HPCA-adhesives.

In some embodiments, an adhesive described herein may have no detectable glass transition temperature. As used herein, the term “no detectable glass transition temperature” and derivatives thereof refers to material having no detectable heat flow event (as measured by DSC), which may be caused by the plasticized material having no glass transition temperature or the heat flow broadening to an extent that the glass transition temperature is not detectable.

Tailoring the melt flow index of HPCA-adhesives described herein may enable the use of the HPCA-adhesives over a wide variety of applications. For example, lower melt flow index HPCA-adhesives may be useful in applications where shape is retained until heating (e.g., window films, glue sticks, and pelletized HPCA-adhesives), while higher melt flow index HPCA-adhesives may be useful in applications where pliable or even spreadable HPCA-adhesives are desired (e.g., for creating thin films for self-adhesive stamps and envelopes). In some embodiments, tailoring the melt flow index of the HPCA-adhesives described herein may be achieved by, inter alia, changing the plasticizer composition, changing the plasticizer concentration (e.g., increasing the concentration to increase the melt flow index), changing the molecular weight of the cellulose acetate (e.g., decreasing molecular weight to increase the melt flow index), and changing the composition and/or concentration of additives (e.g., increasing crosslinker concentration to decrease the melt flow index).

In some embodiments, an HPCA-adhesive described herein may have a melt flow index (with a 300 sec melt time) ranging from a lower limit of about 25 g/10 min, 29 g/10 min, 35 g/10 min, or 40 g/10 min (at 150° C./500 g measured in accordance with ASTM D1238) to an upper limit of about 150 g/10 min, 125 g/10 min, 100 g/10 min, 80 g/10 min, 70 g/10 min, 60 g/10 min, 50 g/10 min, or 40 g/10 min (at 150° C./500 g measured in accordance with ASTM D1238), and wherein the melt flow index may range from any lower limit to any upper limit and encompass any subset therebetween. In some instances where the melt flow index at 150° C./500 g is greater than 150 g/10 min, the melt flow index may be measured at 150° C./100 g and range from a lower limit of about 5 g/10 min, 25 g/10 min, 29 g/10 min, 35 g/10 min, or 40 g/10 min (at 150° C./100 g measured in accordance with ASTM D1238) to an upper limit of about 86 g/10 min, 80 g/10 min, 70 g/10 min, 60 g/10 min, 50 g/10 min, or 40 g/10 min (at 150° C./100 g measured in accordance with ASTM D1238), and wherein the melt flow index may range from any lower limit to any upper limit and encompass any subset therebetween. In some embodiments, an HPCA-adhesive described herein may have a melt flow index that is higher than can be measured at 150° C./100 g (e.g., greater than about 86 g/10 min at 150° C./100 g).

It should be noted that the melt flow index of the HPCA-adhesives described herein may fall outside the ranges described herein depending on, inter alia, the additive (e.g., fillers, tackifiers, and the like), included in the adhesive. In some embodiments, the HPCA-adhesives described herein may have a melt flow index that is higher than can be measured at 150° C./500 g.

Tailoring the melt viscosity of HPCA-adhesives described herein may enable the use of the HPCA-adhesives over a wide variety of applications. For example, a lower melt viscosity may be useful high-speed processing where it is advantageous to have a low viscosity adhesive (e.g., in adhering labels to bottles). In some embodiments, tailoring the melt viscosity of the HPCA-adhesives described herein may be achieved by, inter alia, changing the plasticizer composition, changing the plasticizer concentration (e.g., increasing the concentration to decrease the melt viscosity), changing the molecular weight of the cellulose acetate (e.g., decreasing molecular weight to decrease the melt viscosity), and changing the composition and/or concentration of additives (e.g., increasing crosslinker and/or tackifier concentration to increase the melt viscosity).

The melt viscosity of HPCA-adhesives described herein may be measure by rheometers (rotational, or capillary). In some embodiments, an HPCA-adhesive described herein may have a melt viscosity measure at 150° C. and 100 s¹ ranging from a lower limit of about 500 cP, 1,000 cP, 2,500 cP, or 5,000 cP to an upper limit of 200,000 cP, 150,000 cP, 50,000 cP, 10,000 cP, and wherein the melt viscosity may range from any lower limit to any upper limit and encompass any subset therebetween.

Factors that affect the melt viscosity of an adhesive described herein may include, but are not limited to, plasticizer concentration in the HPCA (e.g., a higher concentration of plasticizer may decrease the melt viscosity), HPCA concentration in the adhesive described herein (e.g., a higher concentration of HPCA may increase the melt viscosity), the composition of the cellulose acetate and the additional polymer blended with the HPCA, and the like, and combinations thereof.

Tailoring the adhesive strength of HPCA-adhesives described herein may enable the use of the HPCA-adhesives over a wide variety of applications. For example, a lower adhesive strength may be useful in semi-permanent adhesive applications (e.g., between substrates with lower mechanical properties as in sticky-notes or peelable protective coatings), while higher adhesive strength may be useful in permanent to semi-permanent applications between substrates with higher mechanical properties (e.g., adhering the cardboard packaging of mailing boxes or laminating applications). Further, in some instances, higher adhesive strength may be useful in forming a film (or coating) on a substrate (e.g., laminating paper, glass, metal, and the like such that the HPCA-adhesive forms a protective coating/laminate on the substrate). In some embodiments, tailoring the adhesive strength of the HPCA-adhesives described herein may be achieved by, inter alia, changing the plasticizer composition, changing the plasticizer concentration (e.g., increasing the concentration to decrease the adhesive strength), changing the molecular weight of the cellulose acetate (e.g., decreasing molecular weight to decrease the adhesive strength), and changing the composition and/or concentration of additives (e.g., increasing crosslinker and/or tackifier concentration to increase the adhesive strength).

In some embodiments, the HPCA-adhesives described herein may have an adhesive shear strength ranging from a lower limit of about 0.2 kgf, 0.5 kgf, 1 kgf, 2 kgf, or 4 kgf to an upper value limited by the force required to tear the substrate, and wherein the adhesive shear strength may range from any lower limit to any upper limit and encompass any subset therebetween. In some embodiments, the HPCA-adhesives described herein may have an adhesive shear strength ranging from a lower limit of about 0.2 kgf, 0.5 kgf, 1 kgf, 2 kgf, or 4 kgf to an upper limit of about 10 kgf, 8 kgf, 6 kgf, or 4 kgf, and wherein the adhesive shear strength may range from any lower limit to any upper limit and encompass any subset therebetween. The adhesive shear strength of an HPCA-adhesive can be measured by testing lap shears by tension loading with a 1 kN load cell by a method that includes placing a specimen in the grips of the testing machine so that each end is in contact with the grip assemble, applying the loading immediately to the specimen at the rate of 800 lb force of shear per min, and continuing the load to failure. Substrate failure was observed above the strength of 8 kgf for paper substrates and a glue line less than 3 mm thick. This value may change depending on the substrate and size of the glue line.

Tailoring the degradability of HPCA-adhesives described herein may contribute to the overall degradability of products and articles comprising the HPCA-adhesives. In some embodiments, tailoring the degradability of the HPCA-adhesives described herein may be achieved by, inter alia, changing the plasticizer composition (e.g., utilizing a plasticizer that biodegrades or dissipates into the environment at a higher rate to increase the degradability), changing the plasticizer concentration (e.g., increasing the concentration to increase the degradability), changing the degree of substitution of the cellulose acetate (e.g., decreasing the degree of substitution to increase the degradability), and changing the composition and/or concentration of additives (e.g., increasing antioxidant and/or stabilizer concentration to decrease the degradability).

In some embodiments, the HPCA-adhesives described herein may degrade to a greater extent than a cellulose diacetate material plasticized with 20% triacetin. In some embodiments, the HPCA-adhesives may degrade by about 5% or greater by weight than a cellulose diacetate material plasticized with 20% triacetin in a procedure performed according to EN13432 “Requirements for Packaging Recoverable through Composting and Biodegradation—Test Scheme and Evaluation Criteria for the Final Acceptance of Packaging.” In some embodiments, the HPCA-adhesives may degrade by an amount ranging from a lower limit of about 5%, 10%, or 15% to an upper limit of about 300%, 200%, 100%, 50%, 40%, or 30% by weight than a cellulose diacetate material plasticized with 20% triacetin in a procedure performed according to EN13432 “Requirements for Packaging Recoverable through Composting and Biodegradation—Test Scheme and Evaluation Criteria for the Final Acceptance of Packaging,” and wherein the degradation may range from any lower limit to any upper limit and encompass any subset therebetween. In some instances, the comparative rate of degradation may be outside the ranges described herein depending on the concentration of the plasticizer, the composition of the plasticizer, and the composition of the cellulose acetate.

The clarity of the HPCA-adhesives described herein may be important in some applications, e.g., high clarity (or low haze) may be necessary when the HPCA-adhesives are used in conjunction with high clarity (or low haze) films (e.g., window tints or CLARIFOIL® packaging) or high clarity laminate films (e.g., laminate or protective coatings on substrates like paper, glass, metal, polymer films). In some embodiments, tailoring the clarity of the HPCA-adhesives described herein may be achieved by, inter alia, changing the plasticizer concentration (e.g., increasing the concentration to increases the clarity/decrease the haze) and changing the composition and/or concentration of additives (e.g., increasing the filler concentration to decrease the clarity/increase the haze).

In some embodiments, the HPCA-adhesives described herein may have a haze ranging from a lower limit of about 2, 5, 7, 10, 15, 20, or 25 to an upper limit of about 45, 40, 35, 30, or 25, and wherein the haze may range from any lower limit to any upper limit and encompass any subset therebetween. The haze of an HPCA-adhesive can be measured with properly sized specimens having substantially plane-parallel surfaces (e.g., flat without wrinkling) free of dust, scratches, particles and a thickness of about 0.85 mm using an UtraScan Pro from Hunter Lab with D65 Illuminant/10° observer. One skilled in the art with the benefit of this disclosure would understand that the haze value may fall outside the preferred ranges described herein for different thickness of an HPCA-adhesive sample. In some instances, the haze value may be significantly larger than the preferred ranges above (e.g., about 100) when additives like titanium dioxide are used in significant quantities to produce an opaque HPCA-adhesive. Additionally, pigments and dyes may affect the haze of the HPCA-adhesive. Accordingly, within the scope of the embodiments described herein, the haze may range from about 2 to about 100, including subsets therebetween, depending on the composition and concentration of additives included in the HPCA-adhesives.

Some embodiments described herein may involve producing HPCA-adhesives described herein, which may involve compounding (or otherwise mixing) cellulose acetates described herein and plasticizers described herein at a suitable concentration, which may optionally involve heating (e.g., forming an HPCA-adhesive melt). In some instances, compounding may involve high-shear mixing processes, which may optionally involve heating.

Some embodiments may involve using the HPCA-adhesives immediately for an application (e.g., applying an HPCA-adhesive melt to a substrate so as to form a laminate surface on the substrate), while other embodiments may involve forming the HPCA-adhesives into a desired form. Depending on their characteristics, the HPCA-adhesives described herein may be in a desired form, e.g., a paste, a putty, pellets, or a molded shape (e.g., a glue stick or an adhesive sheet). It should be noted that the term “sheet” should not be interpreted to be limited in thickness and encompasses films, layers, and the like.

In some embodiments, HPCA-adhesives in sheet form may comprise plasticizers in an amount ranging from a lower limit of about 30%, 35%, or 40% to an upper limit of about 70%, 55%, or 40% by weight of the HPCA-adhesive, and wherein the amount may range from any lower limit to any upper limit and encompasses any subset therebetween. In some embodiments, the HPCA-adhesives in sheet form may be smooth and substantially non-tacky at room temperature. In some embodiments, the HPCA-adhesives in sheet form may be heated to initiate adhesion to a surface(s) (e.g., iron-on designs or laminating sheets disposed between one or two substrates). In some embodiments, the sheet may be disposed on one or between two release liners that are easily removed and serves to protect the sheet from adhering to another surface. For example, a release liner may be useful to mitigate an HPCA-adhesive in sheet form from adhering to itself when in a roll, especially an HPCA-adhesive in sheet form with higher plasticizer concentrations.

In some embodiments, HPCA-adhesives in sheet form may have a thickness ranging from a lower limit of about 15 microns, 20 microns, 30 microns, 50 microns, or 100 microns to an upper limit of about 1200 microns, 800 microns, 400 microns, 200 microns, or 100 microns, and wherein the thickness may range from any lower limit to any upper limit and encompasses any subset therebetween. While these thicknesses may be preferred, one skilled in the art, with the benefit of this disclosure, should understand that the thicknesses described are not limiting to the structure of a sheet described herein and thicknesses outside these ranges may be achieved.

HPCA-adhesives may be particularly advantageous as a laminate on a substrate in that the HPCA-adhesive may function as both the adhesive and the film (i.e., not requiring a second adhesive to adhere to a surface and cooling to a laminate form). In some embodiments, HPCA-adhesives in laminate form on a substrate may be produced from an HPCA-adhesive melt comprising plasticizers in an amount ranging from a lower limit of about 30%, 35%, or 40% to an upper limit of about 75%, 60%, 50%, or 45% by weight of the HPCA-adhesive melt, and wherein the amount may range from any lower limit to any upper limit and encompasses any subset therebetween. The plasticizer concentration in the melt and subsequent heating to drive off additional plasticizer may each be tuned to provide a HPCA-adhesive in laminate form with varying properties (e.g., flexibility and rigidity).

In some embodiments, the HPCA-adhesives in laminate form on a substrate may be produced by applying an HPCA-adhesive melt to the substrate (e.g., via melt casting); and allowing the HPCA-adhesive melt to cool, thereby yielding the laminate on the substrate. In some embodiments, the HPCA-adhesives in laminate form on a substrate may be smooth and substantially non-tacky at room temperature. In some embodiments, the HPCA-adhesive melt may comprise HPCA-adhesive that is tacky at room temperature and melted to increase the flow of the HPCA-adhesive. In some embodiments, the HPCA-adhesive melt may comprise HPCA-adhesive that is non-tacky at room temperature and melted to allow for the flow of the HPCA-adhesive.

In some instances, a higher plasticizer concentration may be preferred to increase the flow of the HPCA-adhesive melt at lower temperatures. A HPCA-adhesive melt with increased flow may yield laminates with more uniform thickness and allow for thinner laminates, which tend to be more flexible. More uniform thicknesses provide for higher quality articles and, in some instances, higher clarity laminates.

Some embodiments may further involve treating the laminate to reduce the concentration of plasticizer in the laminate. Treating may involve drying, heating, applying vacuum, and the like, and any combination thereof. Reducing the concentration of the plasticizer may increase the stiffness and chemical resistance of the laminate.

Some embodiments may further involve treating the laminate to change surface chemistry of the laminate. For example, a caustic bath may be utilized to produce a laminate with a superhydrophilic surface.

In some embodiments, HPCA-adhesives in laminate form on a substrate may have a thickness ranging from a lower limit of about 15 microns, 20 microns, 30 microns, 50 microns, or 100 microns to an upper limit of about 500 microns, 400 microns, 300 microns, 200 microns, or 100 microns, and wherein the thickness may range from any lower limit to any upper limit and encompasses any subset therebetween. While these thicknesses may be preferred, one skilled in the art, with the benefit of this disclosure, should understand that the thicknesses described are not limiting to the structure of a laminate described herein and thicknesses outside these ranges may be achieved.

In some embodiments, HPCA-adhesives in pellet form or molded shapes may comprise plasticizers in an amount ranging from a lower limit of about 30%, 35%, or 40% to an upper limit of about 65%, 55%, or 45% by weight of the HPCA-adhesive, and wherein the amount may range from any lower limit to any upper limit and encompasses any subset therebetween. In some embodiments, HPCA-adhesives in pellet form or molded shapes may be tacky. In some embodiments, the HPCA-adhesives in pellet form or molded shapes may be smooth and substantially non-tacky at room temperature. The suitable amount of plasticizer in the HPCA-adhesives to achieve pellet form or molded shapes may depend on, inter alia, the degree of substitution of the cellulose acetates, the composition of the cellulose acetates, the molecular weight of the cellulose acetates, and the composition of the plasticizers.

In some embodiments, HPCA-adhesives in a paste or putty form may comprise plasticizers in an amount of about 40% or greater by weight of the HPCA-adhesive. In some embodiments, HPCA-adhesives in a paste or putty form may comprise plasticizers in an amount of about 40%, 45%, 50%, or 60% to an upper limit of about 80%, 75%, 70%, 65%, or 60% by weight of the HPCA-adhesive, and wherein the amount may range from any lower limit to any upper limit and encompasses any subset therebetween. In some embodiments, HPCA-adhesives in a paste or putty form may be tacky. In some embodiments, HPCA-adhesives in a paste or putty form may be smooth and substantially non-tacky. The suitable amount of plasticizer in the HPCA-adhesives to achieve a paste or putty form may depend on, inter alia, the degree of substitution of the cellulose acetates, the composition of the cellulose acetates, the molecular weight of the cellulose acetates, and the composition of the plasticizers.

Forming the HPCA-adhesives into a desired form may, in some embodiments, be a consequence of compounding, e.g., a paste or a putty. Forming the HPCA-adhesives into a desired form may, in some embodiments, involve methods like extruding, injection molding, blow molding, over molding, compression molding, casting, calendaring, near net shape molding, melt casting, and the like, any hybrid thereof, and any combination thereof.

In some embodiments, additives may be incorporated into HPCA-adhesives by inclusion in the compounding or other mixing step. In some embodiments, additives may be incorporated into HPCA-adhesives after the compounding or other mixing step by, for example, absorption. Absorption may, in some embodiments, be advantageous for the incorporation of volatile additives and/or small molecule additives, e.g., some fragrances, aromas, dyes, and pigments.

In some embodiments, the HPCA-adhesives described herein may be suitable for high-speed coating/adhering methods because there is little to no dry time associated with their application and the melt flow properties of the adhesive composition can be tailored for fast coating processes. This is especially advantageous for laminate coatings and label application. By contrast, emulsion formulations that are used for adhesives and laminate coatings require drying through hundreds of feet of ovens to achieve the desired final product. At least some of the HPCA-adhesives described herein suitable for similar applications, on the other hand, need only cool to achieve a comparable final product. In some instances, a brief heating may be performed to drive off plasticizer, but because the HPCA-adhesives described herein may include volatile to semi-volatile plasticizers, the time and distance associated with heating would be significantly less. Reducing the time and distance associated with heating would advantageously reduce energy costs and machinery footprint.

### II. Articles Comprising HPCA-Adhesives and Methods Relating Thereto

In some embodiments, an article may comprise a first surface having an HPCA-adhesive described herein disposed thereon such that the HPCA-adhesive is exposed to the local environment (e.g., a window tint, window film, light films, light filters, iron-on designs, laminates, substrate coatings, peelable layers or films, and the like).

In some embodiments, an article may comprise a first surface adhered to a second surface with an HPCA-adhesive described herein. In some embodiments, at least one of the surfaces may be chosen so as to be releasable (e.g., a peelable layer) from the HPCA-adhesive, e.g., an envelope with an adhesive between the paper and a release strip. In some embodiments, the first surface and the second surface may correspond to a first substrate and a second substrate, respectively. In some embodiments, the first surface and the second surface may correspond to a single substrate, e.g., a single piece of paper rolled into a cylinder and adhered to itself. In some embodiments, articles described herein may be extended to three or more surfaces, including hundreds or thousands of surfaces (e.g., adhesive book bindings), without departing from the spirit of this disclosure.

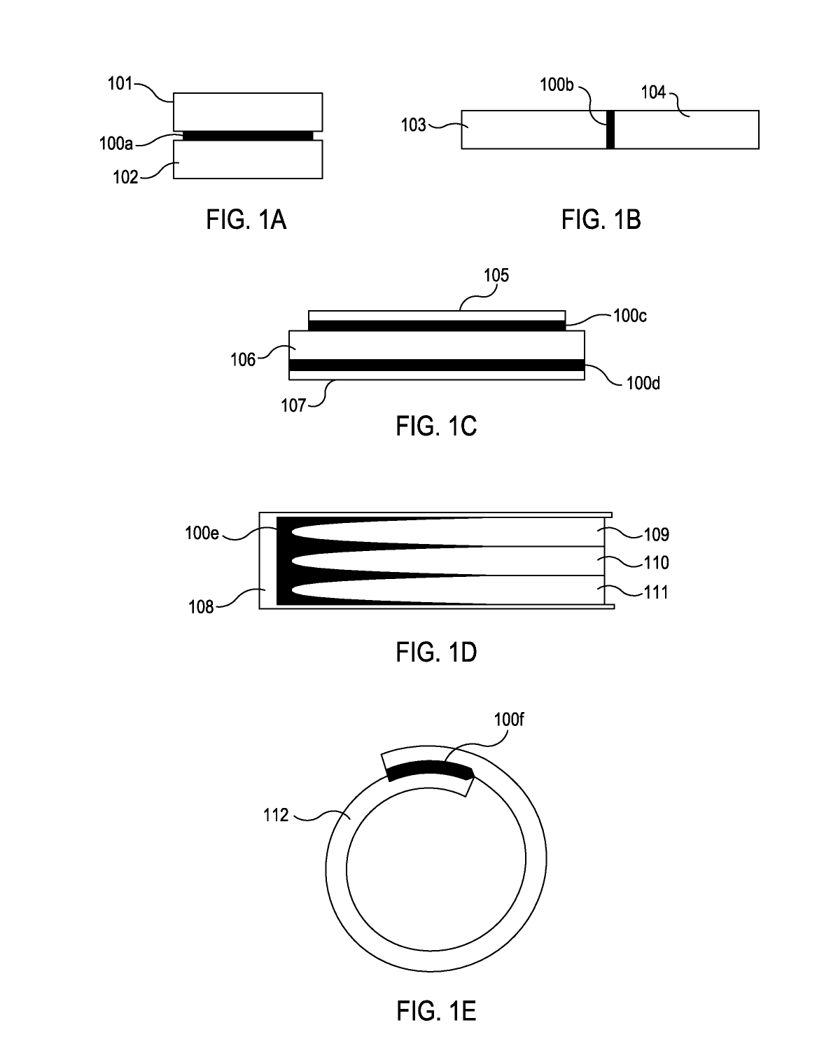

In some embodiments, the articles described herein may be designed with the first surface and the second surface adhered in any suitable configuration. Examples of suitable configurations may, in some embodiments, include, but are not limited to, those illustrated in FIG. 1. FIG. 1A illustrates a first substrate 101 and a second substrate 102 adhered together with an HPCA-adhesive 100a in a stacked configuration. FIG. 1B illustrates a first substrate 103 and a second substrate 104 adhered together with an HPCA-adhesive 100b in a side-by-side configuration. FIG. 1C illustrates a first substrate 105, a second substrate 106, and a third substrate 107 adhered together with an HPCA-adhesive 100c,100d in a stacked configuration where each substrate 105,106,107 has different sizes. FIG. 1D illustrates a plurality of substrates in a hybrid configuration, wherein substrates 109,110,111 are each embedded at one end in an HPCA-adhesive 100e which further adheres substrates 109,110,111 to substrate 108. FIG. 1E illustrates a substrate 112 rolled and adhered to itself at a seam with an HPCA-adhesive 100f. One skilled in the art with the benefit of this disclosure should recognize that FIGS. 1A-1E are merely examples of possible configurations of articles described herein and that a multitude of other configurations are possible and within the bounds of this disclosure.

Exemplary examples of articles described herein comprising HPCA-adhesives and at least one substrate (or surface) as described herein may, in some embodiments, include, but are not limited to, smoking articles (e.g., cigarettes), envelopes, tape, cardboard packaging (e.g., mailing packages and food containers like cereal boxes and frozen dinner containers), books, notebooks, magazines, sticky-notes, corrugated boxes, decorative boxes, paper bags, grocery bags, wrapping paper, wallpaper, paper honeycomb, emery boards, electric insulation paper, air filters, papier-mâché articles, carpets, dartboards, furniture or components thereof (e.g., carpet and/or fabric coated headboards, chairs, and stools), picture frames, medical garments (e.g., disposable gowns and surgical masks), bandages, therapeutic patches, feminine hygiene products, diapers, shoes, clothing (e.g., binding), glues for labels (e.g., self-adhesive labels and HM or HMPSA glues for labels (e.g., replacing casein glues)), self-adhesive stamps, self-adhesive window covering films (e.g., protective films for glass or other substrates), self-adhesive window coverings (e.g., decorative window stickers, window films, and window tinting), heat activated films, light films, light filters, iron-on designs, substrates with laminated surfaces (e.g., laminated paper, laminated business cards, a laminated paper board, or a protective covering directly laminated onto a surface like glass), a coated substrate, and the like.

Substrates or surfaces suitable for use in conjunction with articles described herein may, in some embodiments, include, but are not limited to, fibers, woven fiber substrates, nonwoven fiber substrates, foamed substrates, solid substrates, and the like, any hybrid thereof, and any combination thereof.

Substrates or surfaces suitable for use in conjunction with articles described herein may, in some embodiments, comprise materials that include, but are not limited to, ceramics, natural polymers, synthetic polymers, metals, natural materials, carbons, and the like, and any combination thereof. Examples of ceramics may, in some embodiments, include, but are not limited to, glass, quartz, silica, alumina, zirconia, carbide ceramics, boride ceramics, nitride ceramics, and the like, and any combination thereof. Examples of natural polymers may, in some embodiments, include, but are not limited to, cellulose, and the like, any derivative thereof, and any combination thereof. Examples of synthetic polymers may, in some embodiments, include, but are not limited to, cellulose diacetate, cellulose triacetate, synthetic bamboo, rayon, acrylic, aramid, nylon, polyolefins, polyethylene, polypropylene (including biaxially oriented polypropylene substrates), polyethylene terephthalate, polyesters, polyamides, zylon, and the like, any derivative thereof, and any combination thereof. Examples of metals may, in some embodiments, include, but are not limited to, steel, stainless steel, aluminum, copper, and the like, any alloy thereof, and any combination thereof. Examples of natural materials may, in some embodiments, include, but are not limited to, wood, grass, animal hide, and the like, and any combination thereof. Examples of carbons may, in some embodiments, include, but are not limited to, carbon fibers, and the like, any derivative thereof, and any combination thereof.

Exemplary examples of substrates suitable for use in conjunction with the articles described herein may, in some embodiments, include, but are not limited to, paper, cardboard, card stock, sand paper, bond paper, wallpaper, wrapping paper, cotton paper, tipping paper, bleached paper, colored paper, construction paper, sisal paper, coated paper, wax paper, CLARIFOIL® (cellulose diacetate film, available from Celanese Corporation), woven fabrics, continuous filament nonwoven fabrics, carded nonwoven fabrics, tow, fiber bundles, twill, twine, rope, carpet, carpet backing, leather, animal hide, insulation, wood and/or grass derived substrates (e.g., wood veneers, particle board, fiberboard, medium-density fiberboard, high-density fiberboard, oriented strand board, cork, hardwoods (e.g., balsa wood, beech, ash, birch, Brazil wood, cherry, chestnut, elm, hickory, mahogany, maple, oak, rosewood, teak, walnut, locust, mango, alder, and the like), softwoods (e.g., pine, fir, spruce, cedar, hemlock, and the like), rough lumber, finished lumber, natural fibrous material, and bamboo), foam substrates (e.g., memory foams, polymer foams, polystyrene foam, polyurethane foam, frothed polyurethane, and soy-based foams), and the like, and any combination thereof.

By way of nonlimiting example, an article (e.g., a cigarette paper or a paper towel roll) may comprise two surfaces of a single substrate (e.g., a tipping paper or a cardboard) adhered together (e.g., at a seam line) with HPCA-adhesives described herein.

By way of another nonlimiting example, an article (e.g., a cardboard container for shipping or containing food) may comprise two surfaces adhered together with HPCA-adhesives described herein.

By way of yet another nonlimiting example, an article (e.g., a food container) may comprise two surfaces (e.g., a cardboard container and a cellulose diacetate film (like CLARIFOIL®)) adhered together with HPCA-adhesives described herein.

By way of another nonlimiting example, an article (e.g., window tints or window coverings) may comprise a first surface (e.g., a polyester film) with HPCA-adhesives described herein disposed thereon so as to allow for adherence to a second surface (e.g., a glass surface or other similar transparent surface). In some embodiments, the article may comprise, in order, the first surface, the HPCA-adhesives, and a peelable layer that can be removed before adherence to the second surface. In some embodiments, the article may comprise HPCA-adhesives that are smooth and substantially non-tacky at room temperature such that a peelable layer is not required and the HPCA-adhesives may be exposed to air. In such embodiments, heat may be utilized in adhering the first surface to the second surface.

By way of yet another nonlimiting example, an article (e.g., an iron-on design, heat activated film or laminated card) may comprise a surface or substrate (e.g., paper, a fabric, or a polymer film) with HPCA-adhesives disposed thereon. In some instances, the article may then be adhered to another surface (e.g., applying heat so as to adhere an iron-on design or heat activated film to another surface like a piece of clothing or other fabric). In some embodiments, the article may be formed by applying an HPCA-adhesive melt to the surface or substrate and allowing the HPCA-adhesive melt to cool so as to form a laminate on the surface or substrate.

By way of another nonlimiting example, an article (e.g. a labelled bottle) may comprise a first surface (e.g., a plastic or glass container) to which an HPCA-adhesive may be applied for use in adhering a second surface (e.g., a paper label, a plastic label, or a CLARIFOIL® label) to the first surface. In some instances, the HPCA-adhesive may be on the second surface before application to the first surface. The HPCA-adhesive may have unique advantages in relation to recycling of the bottles. For example, the components of at least some of the HPCA-adhesives described herein are compatible with the current plastic recycling technologies (which allows for a 100% recyclable bottle) and glass bottle washing technologies (which allows for labels to be removed in caustic baths without additional steps and cost). Other technologies that provide this benefit includes some emulsion adhesives, however, as described above, their application when producing labeled bottles is more energy and labor intensive. Therefore, the adhesive compositions described herein provide for a more environmentally friendly adhesive from production (i.e., from natural products) to application to recycling.

Some embodiments described herein may involve adhering two or more surfaces together using HPCA-adhesives described herein. In some embodiments, adhering may involve heating the HPCA-adhesives and/or applying pressure to the HPCA-adhesives.

In some embodiments, adhering surfaces together may involve heating an HPCA-adhesive described herein to yield an adhesive melt; applying the adhesive melt to a first surface; and adhering a second surface to the first surface with the adhesive. While any of the HPCA-adhesives described herein may be suitable for producing adhesive melts, in some preferred embodiments, HPCA-adhesives used for producing adhesive melts may comprise plasticizers in an amount of about 15% to about 70% by weight of the adhesive composition.

In some embodiments wherein an HPCA-adhesive described herein is tacky, adhering surfaces together may involve applying the HPCA-adhesive to a first surface; and adhering a second surface to the first surface with the HPCA-adhesive.

In some embodiments, adhering surfaces together may involve disposing an adhesive sheet between a first surface and a second surface; and heating the adhesive sheet so as to adhere the first surface and the second surface together.

Embodiments disclosed herein include:

A. an adhesive that includes a plasticizer in an amount of about 15% or greater by weight of the adhesive; and a cellulose acetate having a relationship between an acetyl value and an intrinsic viscosity (“an AV/IV relationship”) according to Equation 1 of about 2.80 to about 3.85;

B. a method that includes producing an adhesive melt comprising a cellulose acetate and a plasticizer at about 15% or greater by weight of the adhesive to yield an adhesive melt, wherein the cellulose acetate has an AV/IV relationship according to Equation 1 of about 2.80 to about 3.85; and applying the adhesive melt to a substrate;

C. a article that includes the adhesive of Embodiment A disposed on a surface of a substrate; and

D. a first surface adhered to a second surface with the adhesive of Embodiment A.

Each of embodiments A, B, C, and D may have one or more of the following additional elements in any combination: Element 1: wherein the plasticizer is at about 40% or greater by weight of the adhesive; Element 2: wherein the adhesive is tacky at room temperature; Element 3: wherein the AV/IV relationship is about 2.80 to about 3.20; Element 4: wherein the adhesive has a glass transition temperature between about −75° C. and about 190° C.; Element 5: wherein the adhesive has no detectable glass transition temperature above about −75° C.; Element 6: wherein the cellulose acetate has a molecular weight between about 10,000 and about 300,000; Element 7: wherein the plasticizer comprises two or more plasticizers with at least one being selected from those disclosed herein; Element 8: wherein the plasticizer comprises a surfactant; Element 9: wherein the plasticizer comprises at least one plasticizer disclosed herein; Element 10: wherein the adhesive consists essentially of the plasticizer and the cellulose acetate; Element 11: wherein the adhesive consists of the plasticizer and the cellulose acetate; Element 12: wherein the adhesive is a pressure sensitive adhesive; Element 13: wherein the adhesive is a hot melt pressure sensitive adhesive; and Element 14: wherein the adhesive is a hot melt adhesive. By way of non-limiting example, exemplary combinations applicable to A, B, C, D include: Element 1 in combination with Element 2 and optionally in combination with one of Elements 10-11; Element 3 in combination with one of Elements 12-14 and optionally in combination with one of Elements 10-11; Element 7 in combination with one of Elements 12-14 and optionally in combination with one of Elements 10-11; and Element 8 in combination with one of Elements 12-14 and optionally in combination with one of Elements 10-11.

Each of embodiments C and D may include substrates and surfaces of substrates where the substrate is any disclosed herein. In some instances for Embodiment D, the first and second surfaces may correspond to first and second substrates, respectively, that may be selected from the substrates disclosed herein (e.g., wood/paper, paper/paper, paper/glass, plastic/bottle, cellulose diacetate film/paper, etc). In some instances for Embodiment D, the first and second surfaces may correspond to different portions of a single substrate (e.g., paper or cellulose diacetate rolled into a cylinder).

To facilitate a better understanding of the embodiments described herein, the following examples of preferred or representative embodiments are given. In no way should the following examples be read to limit, or to define, the scope of the disclosure.

### Examples

### Example 1

A plurality of adhesive samples was prepared by compounding cellulose acetate and a plasticizer in the amounts and compositions detailed in Table 1. The cellulose acetates tested were CA-1 having a degree of substitution of about 2.5 and a molecular weight (Mₙ) of about 78,000, CA-2 having a degree of substitution of about 2.4 and a Mₙ of about 44,000, and CA-3 having a degree of substitution of about 2.4 and a Mₙ of about 62,000. The characteristics of the adhesive samples and control cellulose acetate samples without plasticizer were measured and are reported in Table 2.

TABLE 1

| | Cellulose | | |
|---|---|---|---|
| | Acetate | Plasticizer | |
| Sample | Composition | Composition | Wt % Plasticizer |
| CA-1 | CA-1 | | 0 |
| HPCE-1 | CA-1 | triacetin | 20 |
| HPCE-2 | CA-1 | triacetin | 40 |
| HPCE-3 | CA-1 | triacetin | 60 |
| HPCE-4 | CA-1 | tributyl phosphate | 20 |
| HPCE-5 | CA-1 | tributyl phosphate | 40 |
| HPCE-6 | CA-1 | tributyl phosphate | 60 |
| CA-2 | CA-2 | | 0 |
| HPCE-7 | CA-2 | triacetin | 60 |
| HPCE-8 | CA-2 | triacetin | 70 |
| HPCE-9 | CA-2 | tributyl phosphate | 60 |
| CA-3 | CA-3 | | 0 |
| HPCE-10 | CA-3 | triacetin | 60 |
| HPCE-11 | CA-2 | eugenol | 50 |
| HPCE-12 | CA-2 | ethylvanillin | 50 |
| HPCE-13 | CA-2 | triacetin and | 62 |
| | | ethylvanillin | (92:8 triacetin:ethylvanillin) |
| HPCE-14 | CA-2 | triacetin and | 64 (84:16) |
| | | ethylvanillin | |
| HPCE-15 | CA-2 | acetovanillone | 50 |
| HPCE-16 | CA-2 | triacetin and | 62 (92:8) |
| | | acetovanillone | |

TABLE 2

| | | | | Complex |
|---|---|---|---|---|
| | | | | Viscosity³ |
| Sample | Description | MP¹ (° C.) | T_{g}² (° C.) | (Pa * s) |
| CA-1 | white flake | | 167-207⁴ | |
| HPCE-1 | clear; stiff; brittle | | 80 | 93,777 |
| HPCE-2 | clear; flexible; tacky | | −55 | 7,187 |
| HPCE-3 | clear; flexible; | 150¹ | −53 | 2,417 |
| | stretchy; very tacky | | | |
| HPCE-4 | clear; stiff; brittle | 166² | none | 122,456 |
| | | | detected | |
| HPCE-5 | clear; stiff with | 180² | 14 | 56,004 |
| | some flexibility | | | |
| HPCE-6 | clear; flexible; tacky | 180¹ | 12 | 13,661 |
| CA-2 | white flake | | 167-207⁴ | |
| HPCE-7 | clear; flexible; | | −44 | 4,037 |
| | stretchy; tacky | | | |
| HPCE-8 | gel-like | | −61 | 4,037 |
| HPCE-9 | clear; flexible | | 15 | 23,230 |
| CA-3 | white flake | | 167-207⁴ | |
| HPCE-10 | clear; flexible; | | −57 | |
| | stretchy; tacky | | | |
| HPCE-11 | clear; coloured; | | −43 | |
| | tacky; flexible | | | |
| HPCE-12 | hard; glass-like; | | −35 | |
| | clear-yellow | | | |
| HPCE-13 | clear; flexible | | −53 | |
| HPCE-14 | clear; flexible | | −51 | |
| HPCE-15 | hard; glass-like; | | −34 | |
| | clear yellow | | | |
| HPCE-16 | clear; flexible | | −52 | |

¹Flow onset point as measured by visual inspection upon heating.
²Glass transition temperature as measured by TA Instruments DSC Q2000.
³Complex viscosity at 140° C. by TA Instruments Rheometer Discovery HR-2.
⁴Literature values for cellulose acetate.

### Example 2

Samples HPCE-3, HPCE-6, HPCE-7, and HPCE-9 were tested for adherence between a glass surface and a cardboard surface. A portion of the sample was added to a glass slide and heated to between 60° C. and 100° C. Then a piece of cardboard was applied to the adhesive, which was then allowed to cool. The cardboard piece was then peeled from the glass slide.

Adhesion was achieved in all samples. Upon trying to separate the two substrates, the cardboard pieces adhered with samples HPCE-3, HPCE-6, and HPCE-7 were unable to be peeled without rupturing the cardboard. The cardboard piece adhered with sample HPCE-9 was able to be cleanly peeled from the glass slide.

### Example 3

HPCE-7 was tested for thermal stability by storing in a freezer for over 24 hours two paper surfaces glued together. Once warmed to room temperature, the paper surfaces were manually pulled and remained adhered together. Further, the seam where the HPCE-7 adhered to the two paper surfaces remained flexible after the temperature cycling. This example appears to demonstrate, to at least some extent, the temperature stability of at least some of the adhesive described herein.

### Example 4

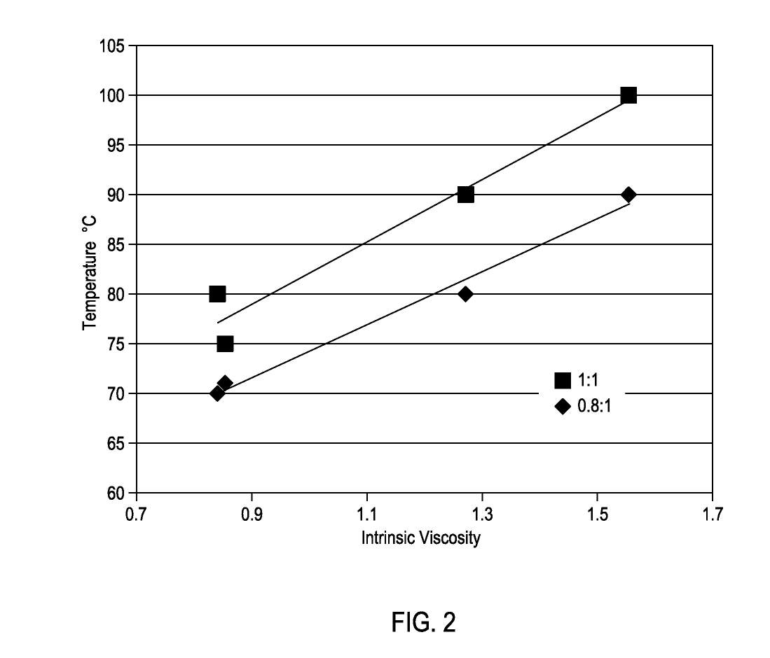

Mixes of CA with intrinsic viscosities from 0.8 to 1.6 and triacetin content to CA ratio of 1:1 and 0.8:1 were prepared. The mixes were analyzed for the changes in melt temperature as a function of intrinsic viscosity. As shown in FIG. 2, a substantially linear relationship was observed where increased intrinsic viscosity yields a linear increase in melt temperature. Further, a higher plasticizer concentration yields a lower melt temperature at the same intrinsic viscosity. This example appears to demonstrate the ability to tailor the flow onset temperature response by controlling intrinsic viscosity or plasticizer concentration of HPCE.

### Example 5

An adhesive melt was prepared by compounding cellulose diacetate (40% by weight of the adhesive melt) with triacetin plasticizer (60% by weight of the adhesive melt) and placing the compounded mixture in an oven for about 5 min at 140° C. The adhesive melt was then coated to one surface/side of a card-stock paper substrate and allowed to cool so as to yield a laminate film on the paper surface. The coated substrate was subjected to an additional heating step at 140° C. for 2-3 minutes. The laminate film was glossy, flexible, and well adhered to the surface precluding the need for both film and laminating adhesive.

### Example 6

A plurality of adhesive samples were prepared by compounding cellulose acetate and a plasticizer in the amounts and compositions detailed in Table 3. The cellulose acetates tested were CA-2 from Example 1 and CA-4 having a degree of substitution of about 2.4, a Mₙ of about 60,000, and an intrinsic viscosity of about 1.36 dL/g. The characteristics of the adhesive samples and control cellulose acetate samples without plasticizer were measured and are reported in Table 4.

TABLE 3

| | Cellulose | | |
|---|---|---|---|
| | Acetate | Plasticizer | |
| Sample | Composition | Composition | Wt % Plasticizer |
| HPCE-17 | CA-4 | diacetin | 60 |
| HPCE-18 | CA-4 | triacetin | 60 |
| HPCE-19 | CA-1 | diacetin | 60 |
| HPCE-20 | CA-4 | diacetin and | 62 (92:8 |
| | | acetylsalicylic acid | diacetin:acetylsalicylic |
| | | | acid) |
| HPCE-21 | CA-4 | triacetin and | 62 (92:8) |
| | | acetylsalicylic acid | |
| HPCE-22 | CA-4 | triacetin and butylated | 62 (92:8) |
| | | hydroxytoluene | |
| HPCE-23 | CA-4 | diacetin and butylated | 62 (92:8) |
| | | hydroxytoluene | |
| HPCE-24 | CA-4 | triacetin and butylated | 62 (92:8) |
| | | hydroxyanisol | |
| HPCE-25 | CA-4 | diacetin and butylated | 62 (92:8) |
| | | hydroxyanisol | |
| HPCE-26 | CA-4 | triacetin and benzoic | 62 (92:8) |
| | | acid | |
| HPCE-27 | CA-4 | diacetin and benzoic | 62 (92:8) |
| | | acid | |
| HPCE-28 | CA-4 | triacetin and | 62 (92:8) |
| | | SYLVATAC ® RE85 | |
| HPCE-29 | CA-4 | diacetin and | 62 (92:8) |
| | | SYLVATAC ® RE85 | |
| HPCE-30 | CA-4 | triacetin and | 62 (92:8) |
| | | SYLVALITE ® | |
| | | RE100 | |
| HPCE-31 | CA-4 | diacetin and | 62 (92:8) |
| | | SYLVALITE ® | |
| | | RE100 | |
| HPCE-32 | CA-2 | triacetin and | 62 (92:8) |
| | | SYLVATAC ® RE85 | |
| HPCE-33 | CA-2 | triacetin and | 62 (92:8) |
| | | SYLVALITE ® | |
| | | RE100 | |
| HPCE-34 | CA-4 | diacetin and ethyl | 62 (92:8) |
| | | vanillin | |
| HPCE-35 | CA-2 | triacetin and ethyl | 62 (92:8) |
| | | vanillin | |
| HPCE-36 | CA-4 | diacetin and salicylic | 62 (92:8) |
| | | acid | |
| HPCE-37 | CA-4 | triacetin and xylitol | 62 (92:8) |
| HPCE-38 | CA-4 | triacetin and sorbitol | 62 (92:8) |
| HPCE-39 | CA-2 | triacetin and xylitol | 62 (92:8) |
| HPCE-40 | CA-2 | triacetin and sorbitol | 62 (92:8) |
| HPCE-41 | CA-2 | triacetin and gamma | 62 (92:8) |
| | | valerolactone | |

TABLE 4

| | | | Melt Flow Index⁶ |
|---|---|---|---|
| Sample | Description | T_{g}⁵ (° C.) | (g/10 min) |
| CA-4 | white flake | 167-207⁷ | |
| HPCE-17 | clear; flexible; stretchy | −69 | 40 |
| HPCE-18 | clear; flexible; stretchy | −53 | 31 |
| HPCE-19 | clear; hard | −66 | 16 |
| HPCE-20 | clear; flexible; | −66 | 57 |
| | stretchy; tacky | | |
| HPCE-21 | clear; flexible; | −54 | 49 |
| | stretchy; tacky | | |
| HPCE-22 | clear-yellow; flexible; | −55 | |
| | stretchy | | |
| HPCE-23 | clear-yellow; flexible; | −63 | 56 |
| | stretchy | | |
| HPCE-24 | clear-yellow; flexible; | −55 | |
| | stretchy; tacky | | |
| HPCE-25 | clear-yellow; flexible; | −62 | 46 |
| | stretchy; tacky | | |
| HPCE-26 | clear-yellow; flexible; | −56 | 51 |
| | stretchy; tacky | | |
| HPCE-27 | clear-yellow; flexible; | −59 | 67 |
| | stretchy; tacky | | |
| HPCE-28 | yellow; flexible | −54 | 45 |
| HPCE-29 | yellow; flexible | −61 | 38 |
| HPCE-30 | white; flexible; | −54 | 68 |
| | stretchy; tacky | | |
| HPCE-31 | white; flexible; | | 47 |
| | stretchy; tacky | | |
| HPCE-32 | white; flexible; | −53 | 27⁸ |
| | stretchy; tacky | | |
| HPCE-33 | white; flexible; | −53 | 21⁸ |
| | stretchy; tacky | | |
| HPCE-34 | clear-yellow; flexible; | −68 | 81 |
| | stretchy; tacky | | |
| HPCE-35 | clear; flexible; | −54 | 34⁸ |
| | stretchy; tacky | | |
| HPCE-36 | clear-yellow; flexible; | −63 | 80 |
| | stretchy; tacky | | |
| HPCE-37 | clear; flexible | −51 | 44 |
| HPCE-38 | clear; flexible | −56 | 41 |
| HPCE-39 | clear; flexible | −55 | |
| HPCE-40 | clear; flexible | −54 | |

⁵Glass transition temperature as measured by TA Instruments DSC Q2000.
⁶Melt flow index measured at 150° C. with a 500 g weight.
⁷Literature values for cellulose acetate.
⁸Melt flow index measured at 150° C. with a 100 g weight.

### Example 7

Some of the adhesive compositions from Tables 1 and 3 were tested for peel adhesion by ASTM 3330/D Method A (180° Peel) after a 24 hour dwell time conditioned at 22° C. and 60% relative humidity. The adhesive strength was measured on stainless steel, glass, and corrugated cardboard and is presented in Table 5.

TABLE 5

| | | | | 180° Peel |
|---|---|---|---|---|
| | | 180° Peel | 180° Peel | Corrugated |
| | Adhesive | Stainless Steel | Glass | Cardboard |
| | Thickness | Substrate 24 hr. | Substrate 24 hr. | Substrate 24 hr. |
| | (mil) | Dwell Time | Dwell Time | Dwell Time |
| Sample | (mil) | Mean (lbf/in) | Mean (lbf/in) | Mean (lbf/in) |
| HPCE-14 | 1.5 | 3.0 | 2.6 | 1.7 |
| HPCE-16 | 5 | 1.7 | 2.4 | 1.4 |
| HPCE-41 | 1.5 | 0.8 | 1.7 | 1.7 |

### Example 8

A plurality of adhesive samples were prepared by compounding cellulose acetate (CA-4 of Example 6) and a plasticizer in the amounts and compositions detailed in Table 6. The characteristics of the adhesive samples were measured and are reported in Table 6.

TABLE 6

| | | | Melt Flow Index⁶ |
|---|---|---|---|
| Sample | Plasticizer | T_{g}⁵ (° C.) | (g/10 min) |
| HPCE-17 | 60 wt % diacetin | −69 | 40 |
| HPCE-42 | 62 wt % diacetin | −68 | 82 |
| HPCE-20 | 57 wt % diacetin and | −66 | 57 |
| | 5 wt % acetylsalicylic acid | | |
| HPCE-43 | 50 wt % acetylsalicylic acid | −21 | less than 1 |
| HPCE-44 | 60 wt % acetylsalicylic acid | −32 | less than 1 |
| HPCE-45 | 33 wt % diacetin and | −57 | 125 |
| | 33 wt % acetylsalicylic acid | | |
| HPCE-46 | 49.5 wt % diacetin and | −59 | 100 |
| | 16.5 wt % acetylsalicylic acid | | |
| HPCE-47 | 16.5 wt % diacetin and | −48 | 100 |
| | 49.5 wt % acetylsalicylic acid | | |

⁵Glass transition temperature as measured by TA Instruments DSC Q2000.
⁶Melt flow index measured at 150° C. with a 500 g weight.

### Example 9

This example appears to demonstrate the synergistic effect on melt flow index using multiple plasticizers in the adhesives described herein. A plurality of adhesive samples were prepared by compounding cellulose acetate (CA-4 of Example 6) and a plasticizer in the amounts and compositions detailed in Table 7. The characteristics of the adhesive samples were measured and are reported in Table 7.

TABLE 7

| | | | Melt Flow Index⁶ |
|---|---|---|---|
| Sample | Plasticizer | T_{g}⁵ (° C.) | (g/10 min) |
| HPCE-17 | 60 wt % diacetin | −69 | 40 |
| HPCE-48 | 60 wt % triethylcitrate | −56 | 15 |
| HPCE-49 | 30 wt % diacetin and | −61 | 45 |
| | 30 wt % triethylcitrate | | |
| HPCE-42 | 62 wt % diacetin | −68 | 82 |
| HPCE-79 | 62 wt % imidazole | −50 | less than 1 |
| HPCE-51 | 57 wt % diacetin and | −62 | 109 |
| | 5 wt % imidazole | | |

⁵Glass transition temperature as measured by TA Instruments DSC Q2000.
⁶Melt flow index measured at 150° C. with a 500 g weight.

### Example 10

This example appears to demonstrate the use of amines as plasticizers in the adhesives described herein. A plurality of adhesive samples was prepared by compounding cellulose acetate (CA-4 of Example 6) and a plasticizer in the amounts and compositions detailed in Table 8. The characteristics of the adhesive samples were measured and are reported in Table 8.

TABLE 8

| Sample | Plasticizer | T_{g}⁵ (° C.) |
|---|---|---|
| HPCE-17 | 60 wt % diacetin | −69 |
| HPCE-50 | 60 wt % imidazole | −53 |
| HPCE-51 | 57 wt % diacetin and | −62 |
| | 5 wt % imidazole | |
| HPCE-52 | 50 wt % ethylene diamine | none |
| | | detected |
| HPCE-53 | 50 wt % piperidine | none |
| | | detected |
| HPCE-54 | 50 wt % piperazine | −60 |
| HPCE-55 | 50 wt % hexanediamine | −65 |

⁵Glass transition temperature as measured by TA Instruments DSC Q2000.

### Example 11

This example appears to demonstrate the effect of tackifiers on the properties of the adhesives described herein. A plurality of adhesive samples were prepared by compounding cellulose acetate (CA-4 of Example 6 or CA-5 (a blend of two cellulose acetates both having a degree of substitution of about 2.3 and each an intrinsic viscosity of about 1.27 dL/g and 1.21 dL/g), a plasticizer, and tackifiers (terpene phenolic resins, SYLVARES™ TP96 and SYLVARES™ TP2040 and rosin esters, SYLVALITE™ RE 100XL, available from Arizona Chemical) in the amounts and compositions detailed in Table 9. The characteristics of the adhesive samples were measured and are reported in Table 9.

TABLE 9

| | | | | | Melt |
|---|---|---|---|---|---|
| | | | | | Flow |
| | | | | | Index |
| | Cellu- | | | T_{g}⁵ | (g/ |
| Sample | lose | Plasticizer | Tackifier | (° C.) | 10 min) |
| HPCE-56 | CA-4 | 57 wt % | 5 wt % | −68 | 51⁶ |
| | | diacetin | SYLVARES ™ | | |
| | | | TP96 | | |
| HPCE-57 | CA-4 | 57 wt % | 5 wt % | −68 | 62⁶ |
| | | diacetin | SYLVARES ™ | | |
| | | | TP2040 | | |
| HPCE-58 | CA-5 | 51 wt % | 15 wt % | −66 | 49⁸ |
| | | diacetin | SYLVARES ™ | | |
| | | | TP2040 | | |
| HPCE-59 | CA-5 | 57 wt % | 5 wt % | none | 10⁸ |
| | | diacetin | SYLVALITE ™ | detected | |
| | | | RE 100XL | | |
| HPCE-60 | CA-5 | 51 wt % | 15 wt % | −62 | 11⁸ |
| | | diacetin | SYLVALITE ™ | | |
| | | | RE 100XL | | |
| HPCE-61 | CA-5 | 47.12 wt % | 14.88 wt % | −62 | 5⁸ |
| | | diacetin | SYLVALITE ™ | | |
| | | | RE 100XL | | |
| HPCE-62 | CA-5 | 42 wt % | 30 wt % | −61 | 30⁸ |
| | | diacetin | SYLVALITE ™ | | |
| | | | RE 100XL | | |
| HPCE-63 | CA-5 | 32.24 wt % | 29.76 wt % | −61 | 32⁶ |
| | | diacetin | SYLVALITE ™ | | |
| | | | RE 100XL | | |

⁵Glass transition temperature as measured by TA Instruments DSC Q2000.
⁶Melt flow index measured at 150° C. with a 500 g weight.
⁸Melt flow index measured at 150° C. with a 100 g weight.

### Example 12

This example appears to demonstrate the effect of nonionic surfactants on the properties of the adhesives described herein. A plurality of adhesive samples were prepared by compounding cellulose acetate (CA-5 of Example 11), a plasticizer, tackifiers, and surfactant (GLYCOMUL® L, sorbitan monolaurate, available from Lonza) in the amounts and compositions detailed in Table 10. The characteristics of the adhesive samples were measured and are reported in Table 10.

TABLE 10

| | | | | | T_{g}⁵ | MFI⁸ |
|---|---|---|---|---|---|---|
| Sample | Cellulose | Plasticizer | Tackifier | Surfactant | (° C.) | (g/10 min) |
| HPCE-59 | CA-5 | 57 wt % | 5 wt % | 0 wt % | none | 10 |
| | | diacetin | SYLVALITE ™ | | detected | |
| | | | RE 100XL | | | |
| HPCE-64 | CA-5 | 43.89 wt % | 18.8 wt % | 5 wt % | −65 | 48 |
| | | diacetin | SYLVALITE ™ | | | |
| | | | RE 100XL | | | |

⁵Glass transition temperature as measured by TA Instruments DSC Q2000.
⁸Melt flow index measured at 150° C. with a 100 g weight.

### Example 13

This example appears to demonstrate the effect of cellulosic source on the properties of the adhesives described herein. A plurality of adhesive samples was prepared by compounding cellulose acetate from different cellulosic sources. CA-4 and CA-5 described in Examples 6 and 11, respectively, were prepared with acetate grade cellulose, which has an alpha-cellulose content of greater than 94%. CA-6 was prepared to have similar degree of substitution and molecular weight as CA-4 but with viscose grade cellulose starting material, which has an alpha-cellulose content of about 90% to about 94%. The adhesive formulations and characteristics are provided in Table 11.

TABLE 11

| | Cel- | | | | MFI |
|---|---|---|---|---|---|
| | lu- | | | T_{g}⁵ | (g/ |
| Sample | lose | Plasticizer | Tackifier | (° C.) | 10 min) |
| HPCE-17 | CA-4 | 60 wt % | 0% | −69 | 40⁶ |
| | | diacetin | | | |
| HPCE-42 | CA-4 | 62 wt % | 0% | −68 | 82⁶ |
| | | diacetin | | | |
| HPCE-65 | CA-6 | 60 wt % | 0% | −67 | 75⁶ |
| | | diacetin | | | |
| HPCE-66 | CA-6 | 62 wt % | 0% | −66 | 101⁶ |
| | | diacetin | | | |
| HPCE-59 | CA-5 | 57 wt % | 5 wt % | none | 10⁸ |
| | | diacetin | SYLVALITE ™ RE | detected | |
| | | | 100XL | | |
| HPCE-60 | CA-5 | 51 wt % | 15 wt % | −62 | 11⁸ |
| | | diacetin | SYLVALITE ™ RE | | |
| | | | 100XL | | |
| HPCE-61 | CA-5 | 47.12 wt % | 14.88 wt % | −62 | 5⁸ |
| | | diacetin | SYLVALITE ™ RE | | |
| | | | 100XL | | |
| HPCE-67 | CA-6 | 57 wt % | 5 wt % | −72 | 44⁸ |
| | | diacetin | SYLVALITE ™ RE | | |
| | | | 100XL | | |
| HPCE-68 | CA-6 | 51 wt % | 15 wt % | −55 | 37⁸ |
| | | diacetin | SYLVALITE ™ RE | | |
| | | | 100XL | | |
| HPCE-69 | CA-6 | 47.12 wt % | 14.88 wt % | −66 | 27⁸ |
| | | diacetin | SYLVALITE ™ RE | | |
| | | | 100XL | | |

⁵Glass transition temperature as measured by TA Instruments DSC Q2000.
⁶Melt flow index measured at 150° C. with a 500 g weight.
⁸Melt flow index measured at 150° C. with a 100 g weight.

### Example 14

This example appears to demonstrate the effect of nonionic surfactants on the properties of the adhesives described herein. A plurality of adhesive samples were prepared by compounding cellulose acetate (CA-5 of Example 11), a plasticizer, tackifiers, and surfactant in the amounts and compositions detailed in Table 12. The characteristics of the adhesive samples were measured and are reported in Table 12.

TABLE 12

| | | | | | MFI⁸ |
|---|---|---|---|---|---|
| Sample | Plasticizer | Tackifier | Surfactant | T_{g}⁵ (° C.) | (g/10 min) |
| HPCE-70 | 37.62 wt % | 25 wt % | 5 wt % | −63 | 31 |
| | diacetin | SYLVALITE ™ | BRIJ L23 | | |
| | | RE 100XL | (30% (w/v) | | |
| | | | in | | |
| | | | H₂O | | |
| HPCE-71 | 37.62 wt % | 25 wt % | 5 wt % | −64 | 41 |
| | diacetin | SYLVALITE ™ | SIDERCEL SF | | |
| | | RE 100XL | 140 | | |
| HPCE-72 | 37.62 wt % | 25 wt % | 5 wt % | −62 | 31 |
| | diacetin | SYLVALITE ™ | TRITON X-100 | | |
| | | RE 100XL | | | |
| HPCE-73 | 37.62 wt % | 25 wt % | 5 wt % | −63 | 17 |
| | diacetin | SYLVALITE ™ | POLYFOX PF- | | |
| | | RE 100XL | 151N | | |
| HPCE-74 | 37.62 wt % | 25 wt % | 5 wt % | −64 | 41 |
| | diacetin | SYLVALITE ™ | GLYCOSPERSE | | |
| | | RE 100XL | L-20 KFG | | |
| HPCE-75 | 39.60 wt % | 26.4 wt % | 0 wt % | −66 | 11 |
| | diacetin | SYLVALITE ™ | | | |
| | | RE 100XL | | | |

⁵Glass transition temperature as measured by TA Instruments DSC Q2000.
⁸Melt flow index measured at 150° C. with a 100 g weight.

### Example 15

This example appears to demonstrate the ability to produce adhesives with base polymers that include HPCE and traditional adhesive polymers (e.g., ethylene vinyl acetate copolymer (“EVA”) and polyvinyl alcohol (“PVOH”)). Interestingly, in these exemplary adhesive compositions, compatibilizers were not required. A plurality of adhesive samples was prepared by compounding cellulose acetate (CA-5 of Example 11), a plasticizer, and an additional polymer in the amounts and compositions detailed in Table 13. The characteristics of the adhesive samples were measured and are reported in Table 13.

TABLE 13

| | | | | | MFI⁸ |
|---|---|---|---|---|---|
| | | | | T_{g}⁵ | (g/ |
| Sample | Cellulose | Plasticizer | Additional Polymer | (° C.) | 10 min) |
| HPCE-76 | 38% CA-5 | 57% | 5% EVA | −62 | 61 |
| | | diacetin | (28% vinyl acetate) | | |
| HPCE-77 | 38% CA-5 | 57% | 5% PVOH | −65 | 40 |
| | | diacetin | (98.4% hydrolysis) | | |
| HPCE-78 | 38% CA-5 | 57% | 5% PVOH | −63 | 34 |
| | | diacetin | (88% hydrolysis) | | |

⁵Glass transition temperature as measured by TA Instruments DSC Q2000.
⁸Melt flow index measured at 150° C. with a 100 g weight.

Therefore, this disclosure is well adapted to attain the ends and advantages mentioned as well as those that are inherent therein. The particular embodiments disclosed above are illustrative only, as the embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. An adhesive comprising:
a plasticizer in an amount of about 15% or greater by weight of the adhesive; and
a cellulose acetate having a relationship between an acetyl value and an intrinsic viscosity (“an AV/IV relationship”) according to Equation 1 of about 2.80 to about 3.85:
$$\frac{{AV}^{2} + {IV}^{2}}{1000} . \qquad Equation 1$$

2. The adhesive of claim 1, wherein the plasticizer is at about 40% or greater by weight of the adhesive.

3. The adhesive of claim 2, wherein the adhesive is tacky at room temperature.

4. The adhesive of claim 1, wherein the AV/IV relationship is about 2.80 to about 3.20.

5. The adhesive of claim 1, wherein the adhesive has a glass transition temperature between about −75° C. and about 190° C.

6. The adhesive of claim 1, wherein the adhesive has no detectable glass transition temperature above about −75° C.

7. The adhesive of claim 1, wherein the plasticizer comprises at least one selected from the group consisting of: Formula 1 wherein R1 is H, C₁-C₄ alkyl, aryl, or C₁-C₄ alkyl aryl; Formula 2 wherein R2 is H, C₁-C₄ alkyl, aryl, or C₁-C₄ alkyl aryl and R3 is H, C₁-C₄ alkyl, aryl, C₁-C₄ alkyl aryl, acyl, or C₁-C₄ alkyl acyl; Formula 3 wherein R4 and R6 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R5 is H, C₁-C₄ alkyl, aryl, C₁-C₄ alkyl aryl, acyl, or C₁-C₄ alkyl acyl; Formula 4 wherein R7 is H, C₁-C₄ alkyl, aryl, C₁-C₄ alkyl aryl, OH, C₁-C₄ alkoxy, amine, or C₁-C₄ alkyl amine and R8 and R9 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 5 wherein R10, R11, and R12 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 6 wherein R13 is H, C₁-C₄ alkyl, aryl, or C₁-C₄ alkyl aryl, R14 and R16 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide, and R15 is H, C₁-C₄ alkyl, aryl, C₁-C₄ alkyl aryl, acyl, or C₁-C₄ alkyl acyl; Formula 7 wherein R17 is H or C₁-C₄ alkyl and R18, R19, and R20 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 8 wherein R21 is H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide and R22 is H, C₁-C₄ alkyl, aryl, C₁-C₄ alkyl aryl, acyl, C₁-C₄ alkyl acyl, amine, or C₁-C₄ alkyl amine; Formula 9 wherein R23 and R24 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 10 wherein R25, R26, R27, and R28 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 11 wherein R29, R30, and R31 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 12 wherein R32 is H, C₁-C₄ alkyl, aryl, C₁-C₄ alkyl aryl, R33 is H, C₁-C₄ alkyl, aryl, C₁-C₄ alkyl aryl, OH, C₁-C₄ alkoxy, acyl, C₁-C₄ alkyl acyl, amine, or C₁-C₄ alkyl amine, and R34, R35, and R36 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 13 wherein R37, R38, R39, and R40 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; Formula 14 wherein R41 is H, C₁-C₄ alkyl, aryl, C₁-C₄ alkyl aryl, OH, or C₁-C₄ alkoxy and R42 and R43 are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazine (1,2,3, 1,2,4, or 1,3,5) with R substituents from each of the cyclic carbons that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; triazole (1,2,3 or 1,2,4) with R substituents from each of the cyclic carbons that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; pyrrole with R substituents from each of the cyclic carbons that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; piperidine with R substituents from each of the cyclic carbons that are independently H, C₁-C₄ alkyl, aryl, C₁-C₄ alkyl aryl, COOH, C₁-C₄ alkyl carboxylate, acyl, C₁-C₄ alkyl acyl, amine, C₁-C₄ alkyl amine, amide, or C₁-C₄ alkyl amide; H₂N—R44-NH₂ where R44 is C₁-C₁₀ alkyl; and combinations thereof

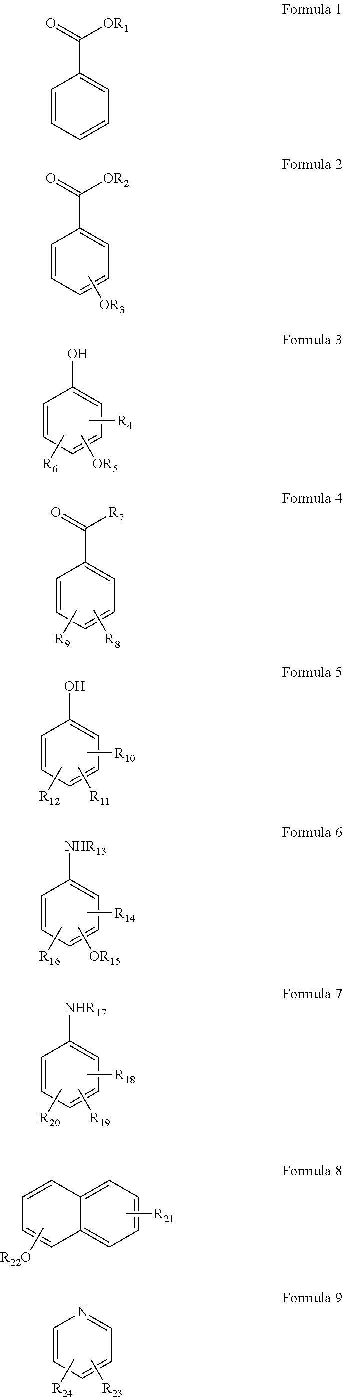

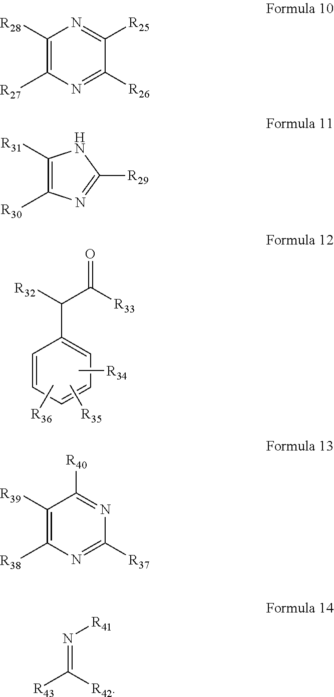

8. The adhesive of claim 1, wherein the plasticizer comprises at least one selected from the group consisting of: triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., γ-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybeonzoate, methyl-4-hydroxybeonzoate, ethyl-4-hydroxybeonzoate, benzyl-4-hydroxybeonzoate, butylated hydroxytoluene, butylated hydroxyanisol, sorbitol, xylitol, ethylene diamine, piperidine, piperazine, hexamethylene diamine, triazine, triazole, pyrrole, any derivative thereof, and any combination thereof.

9. A method comprising:
producing an adhesive melt comprising a cellulose acetate and a plasticizer at about 15% or greater by weight of the adhesive to yield an adhesive melt, wherein the cellulose acetate has a relationship between an acetyl value and an intrinsic viscosity (“an AV/IV relationship”) according to Equation 1 of about 2.80 to about 3.85:
$$\frac{{AV}^{2} + {IV}^{2}}{1000} ; \qquad Equation 1$$
and
applying the adhesive melt to a substrate.

10. The method of claim 9, wherein the plasticizer is at about 40% or greater by weight of the adhesive.

11. The method of claim 10, wherein the adhesive is tacky at room temperature.

12. The method of claim 9, wherein the AV/IV relationship is about 2.80 to about 3.20.

13. The method of claim 9, wherein the adhesive has a glass transition temperature between about −75° C. and about 190° C.

14. The method of claim 9, wherein the adhesive has no detectable glass transition temperature above about −75° C.

15. The method of claim 9, wherein the cellulose acetate has a molecular weight between about 10,000 and about 300,000.

16. An article comprising:
a first surface adhered to a second surface where the adhesive comprises a cellulose acetate and a plasticizer at about 15% or greater by weight of the adhesive to yield an adhesive melt, wherein the cellulose acetate has a relationship between an acetyl value and an intrinsic viscosity (“an AV/IV relationship”) according to Equation 1 of about 2.80 to about 3.85:
$$\frac{{AV}^{2} + {IV}^{2}}{1000} . \qquad Equation 1$$

17. The article of claim 16, wherein the first surface is a portion of a cellulose diacetate film and the second surface is a portion of a paper substrate.

18. The article of claim 16, wherein the first surface is a portion of a paper substrate and the second surface is a portion of a wood substrate.

19. The article of claim 16, wherein the first surface is a portion of a cellulose diacetate film and the second surface is a portion of a plastic substrate.

20. The article of claim 16, wherein the first surface is a first portion of a cellulose diacetate film and the second surface is a second portion of a cellulose diacetate film.
